(19) United States
(12) Patent Application Publication
(10) Pub. No.: US 2026/0071596 A1
(43) Pub. Date: Mar. 12, 2026

(54) Engine Systems and Methods of Their Use

(71) Applicant: Alpha Portfolio LLC, Naples, FL (US)

(72) Inventors: Addison FISCHER, Naples, FL (US); Christopher J. NAGEL, Wayland, MA (US)

(21) Appl. No.: 18/802,514

(22) Filed: Aug. 13, 2024

Related U.S. Application Data
(63) Continuation of application No. PCT/US22/18511, filed on Mar. 2, 2022.

(51) Int. Cl. F02M 21/02; F02B 53/10

(52) U.S. Cl. CPC F02M 21/0206; F02B 53/10; F02M 21/0227

(57) ABSTRACT

The invention includes engines adapted for using apparatuses and methods for instantiating chemical reactants in a nanoporous carbon powder, and further includes methods of use for such engines.

### RELATED APPLICATION

This application is a continuation of International Application No. PCT/US22/18511, which designated the United States and was filed on Mar. 2, 2022, published in English. The entire teachings of the above application are incorporated herein by reference.

### BACKGROUND OF THE INVENTION

A typical internal combustion engine comprises a housing structure such as an engine block that houses one or more internal combustion chamber(s). A fuel-air mixture is introduced into the combustion chamber(s), and a spark or other ignition mechanism controllably ignites the fuel-air mixture within the chamber(s). Expanding gases resulting from combustion drive a mechanical part such as a reciprocating piston, a rotating rotor and/or a rotating turbine to provide drive power for cars, motorcycles, ships, airplanes, helicopters, trains, electrical generators, and countless other machines. Such engine technology changed the world when it was invented in the mid-19^{th} Century and has since become ubiquitous.

While many improvements to engine design have been proposed or implemented, further improvements are possible and desirable. In particular, it would be highly desirable to offer improved technologies for fueling engines and powering the machines that use them, including but not limited to internal combustion engines, turbine engines, and other machines.

Current sources for fuels for engines are in large part derived from hydrocarbon sources, which impose burdens on the environment. For example, the use of coal or petroleum as fuel sources requires energy for obtaining and refining these raw materials, and further generates carbon dioxide when they undergo combustion. As another example, while hydrogen fuels can be used to power engines without producing carbon dioxide, hydrogen itself is commonly produced from other hydrocarbon precursor materials (such as steam reforming of methane and coal gasification), or from electrolysis, which requires energy input. Moreover, once produced, hydrogen is typically stored in a high-pressure tank or a cryogenic tank, making it less convenient to use in smaller, more portable situations such as for engines that power moving vehicles. There remains a need in the art, therefore, to provide a fuel source to power engines efficiently and conveniently, without the logistical drawbacks and environmental stresses of conventional engine technologies.

### SUMMARY OF THE INVENTION

The present invention relates to the discovery that apparatuses containing carbon matrices can be used to produce reactant chemicals useful as fuels for use in a variety of engines. The processes of the invention include the application of electromagnetic radiation, directly and/or indirectly, to gases, nano-porous carbon, or compositions and combinations thereof, thereby pre-treating the gas, and exposing a carbon matrix to pre-treated gas in an apparatus of the invention and recovering those reactant chemicals that are subsequently used as fuels in engines.

The invention relates to apparatuses for instantiating materials, and processes for using such apparatuses. The invention includes processes comprising the steps of contacting a bed comprising nanoporous carbon with an activated gas while applying electromagnetic radiation to the nanoporous carbon for a time sufficient to cause instantiation of the fuel substance and collecting the fuel substance. The invention further relates to the fuel substance produced by the process.

More specifically, the invention includes a process of instantiating a chemical reactant within a nanoporous carbon powder comprising the steps of:
(i) adding a nanoporous carbon powder into a reactor assembly (RA), as described below,
(ii) adding a feedgas composition to the reactor assembly, wherein the feedgas composition is free of the desired fuel substance;
(iii) powering one or more RA coils to a first electromagnetic energy level;
(iv) subjecting the nanoporous carbon powder (the terms nanoporous carbon powder, nanoporous carbon material and nanoporous carbon are used herein interchangeably) to harmonic patterning to instantiate the chemical reactant in product compositions;
(v) collecting the product compositions comprising the chemical reactant; and
(vi) optionally isolating the chemical reactant from the product compositions.

In one embodiment, the RA coil surrounds a nanoporous carbon bed to establish a harmonic electromagnetic resonance in ultramicropores of the nanoporous carbon powder. The feed gas composition can be, for example, air, oxygen, hydrogen, helium, nitrogen, neon, argon, krypton, xenon, carbon monoxide, carbon dioxide or mixtures thereof, preferably nitrogen or air. Preferably, the nanoporous carbon powder comprises graphene having at least 99.9% wt. carbon (metals basis), a mass mean diameter between 1 μm and 5 mm, and an ultramicropore surface area between about 100 and 3000 m²/g.

More specifically, the invention includes a reactor assembly comprising:
(a) A reactor chamber containing a nanoporous carbon material;
(b) A second porous frit defining the ceiling of the reactor chamber; wherein each porous frit has a porosity that is sufficient to allow a gas to permeate into the reactor chamber and contain a nanoporous carbon material;
(c) A reactor head space disposed above the reactor cap;
(d) 1, 2, 3, 4, 5 or more RA coils surrounding the reactor chamber and/or reactor head space operably connected to one or more RA frequency generators and/or one or more power supplies;
(e) 0, 1, 2, 3, 4, 5 or more pairs of RA lamps wherein the pairs of RA lamps are disposed circumferentially around the RA coils and define a space between the pairs of RA lamps and the RA coils, when present;
(f) An optional x-ray source configured to expose the reactor chamber to x-rays;
(g) One or more optional lasers configured to direct a laser towards (e.g., through or across) the reactor chamber or the gas within the reactor assembly, when present; and
(h) A computer processing unit (CPU) configured to control the power supply, frequency generator, x-ray source, lamps and/or lasers.

As will be described in more detail below, the gas inlet of the reactor assembly can be in fluid connection with at least one gas supply selected from the group consisting of air, oxygen, hydrogen, helium, nitrogen, neon, argon, krypton, xenon, carbon monoxide, carbon dioxide and mixtures thereof; and/or (iii) the gas supply is directed through a gas manifold controlled by mass flow meters.

As will be described in more detail below, the nanoporous carbon powder charged to the reactor assembly can comprise graphene having at least 95% wt. carbon (metals basis), a mass mean diameter between 1 μm and 5 mm, and an ultramicropore surface area between about 100 and 3000 m²/g. The nanoporous carbon powder is preferably characterized by acid conditioning, wherein the acid is selected from the group consisting, without limitation, of HCl, HF, HBr, HI, sulfuric acid, phosphoric acid, carbonic acid, and nitric acid, and a residual water content of less than that achieved upon exposure to a relative humidity (RH) of less than 40% RH at room temperature. In a preferred embodiment, the process contemplates degassing the nanoporous carbon powder prior to the process.

As will be described in more detail below, the reactor assembly can include a plurality of devices that can impart electromagnetic fields, including x-ray sources, coils, lasers and lamps or lights, including pencil lamps, short wave and long wave lamps. The wavelengths generated by each device (e.g., lamps or lasers) can be independently selected.

As will be described in more detail below, the RA coils can be made from the same or different electrically conducting materials. For example, a first RA coil comprises a copper wire winding, a second RA coil comprises a braiding of copper wire and silver wire, and a third RA coil is a platinum wire winding, and each RA coil is configured to create a magnetic field and wherein each power supply independently provides AC and/or DC current.

As will be described in more detail below, the reactor assembly can be characterized by (i) a first pair of RA lamps configured in a first plane defined by a center axis and a first radius of the reactor chamber, (ii) a second pair of RA lamps configured in a second plane defined by the center axis and a second radius of the reactor chamber and (iii) a third pair of RA lamps configured in a third plane defined by the center axis and a third radius of the reactor chamber. Preferably, each RA lamp is a pencil lamp characterized by a tip substantially equidistant from the central axis and each pair of RA lamps comprises a vertical RA lamp and a horizontal RA lamp. Preferably each pair of lamps is equidistantly spaced around the circumference of the reactor chamber.

As will be described in more detail below, the reactor assembly further comprises an electromagnetic embedding enclosure (E/MEE or EMEE), as defined more specifically below. The E/MEE is typically located along a gas line upstream of the reactor assembly gas inlet. Typically, an electromagnetic embedding enclosure located upstream of the gas inlet comprises:
(a) a gas inlet;
(b) at least one E/MEE pencil lamp positioned below the internal gas line, at least one E/MEE pencil lamp positioned above the internal gas line and at least one E/MEE pencil lamp positioned to the side of the internal gas line;
wherein each E/MEE pencil lamp is independently rotatably mounted, located along the length of the internal gas line, and
the lamps and/or coil(s) are powered by a power supply, preferably the power supply of the reactor assembly;
the gas flow, lamps and/or coil(s) are preferably independently controlled by one or more central processing units, preferably the central processing unit (CPU) of the reactor assembly. Typically, a CPU independently controls powering each E/MEE pencil lamp and a rotation position of each E/MEE pencil lamp. It is to be understood that the term “independently” is not meant to be absolute, but is used to optimize results. Rather, controlling each RA coil, lamp and/or laser (each a device) such that it is powered (or rotated) at the same time or at a time specified before and/or after another device is meant to be “independently” controlled. Thus, assigning two or more devices to a power supply and control unit in series is contemplated by the term. The term is intended to exclude simply powering (or rotating) all devices simultaneously.

As will be described in more detail below, the E/MEE housing can be typically closed and opaque, the internal gas line can be transparent and external gas line in fluid connection with the housing outlet and gas inlet can be opaque. Typically, the internal gas line is between 50 cm and 5 meters or more and has a diameter between 2 mm and 25 cm or more.

As will be described in more detail below, the apparatus can have at least 5 E/MEE pencil lamps located along the internal gas line. Each E/MEE pencil lamp can be independently placed such that its longitudinal axis is (i) parallel to the internal gas line, (ii) disposed radially in a vertical plane to the internal gas line, or (iii) perpendicular to the plane created along the longitudinal axis of the internal gas line or along the vertical axis of the internal gas line. Each E/MEE pencil lamp can be independently affixed to one or more pivots that permit rotation, such as, between about 0 and 360 degrees (such as, between 0 and 90 degrees, between 0 and 180 degrees, between 0 and 270 degrees and any angle there between) with respect to the x, y, and/or z axis wherein (i) the x-axis is defined as the axis parallel to the gas line and its vertical plane, (ii) the y-axis defining the axis perpendicular to the gas line and parallel to its horizontal plane, and (iii) the z-axis is defined as the axis perpendicular to the gas line and parallel to its vertical plane.

As will be described in more detail below, at least one E/MEE pencil lamp can be a neon lamp, at least one E/MEE pencil lamp can be a krypton lamp, and at least one E/MEE pencil lamp can be an argon lamp. It can be desirable to match, or pair, one or more E/MEE pencil lamps with one or more (e.g., a pair) of RA lamps. Accordingly, at least one pair of RA pencil lamps can be selected from the group consisting of a neon lamp, a krypton lamp and an argon lamp.

As will be described in more detail below, the invention also includes nanoporous carbon powder compositions or fluid compositions (preferably gas compositions) produced in accordance with the claimed methods and processes.

As will be described in more detail below, the invention includes a process of producing a nanoporous carbon composition comprising the steps of: (a) initiating a gas flow in a reactor assembly as described herein; (b) independently powering each RA coil to a first electromagnetic energy level; (c) powering the one or more RA frequency generators and applying a frequency to each RA coil; (d) independently powering each RA lamp; (e) independently powering each laser; (f) powering the x-ray source; and (g) subjecting the nanoporous carbon powder to harmonic electromagnetic resonance in ultramicropores of the nanoporous carbon powder to instantiate fluid compositions (preferably gas compositions) or solid chemical reactants in a nanopore.

The invention also includes a process of producing a nanoporous carbon composition comprising the steps of: (a) initiating a gas flow in a reactor assembly further comprising an E/MEE, as described herein; (b) independently powering each RA coil to a first electromagnetic energy level; (c) powering the one or more RA frequency generators and applying a frequency to each RA coil; (d) independently powering each RA lamp; (e) independently powering each laser; (f) powering the x-ray source; and (g) subjecting the nanoporous carbon powder to harmonic electromagnetic resonance in ultramicropores of the nanoporous carbon powder to instantiate a fluid (preferably gaseous) or solid chemical reactant in a nanopore.

The invention also includes a process of instantiating a fluid (preferably gaseous) or solid chemical reactant within an ultramicropore of a nanoporous carbon powder comprising the steps of: (a) initiating a gas flow in a reactor assembly further comprising an E/MEE, as described herein; (b) independently powering each RA coil to a first electromagnetic energy level; (c) powering the one or more RA frequency generators and applying a frequency to each RA coil; (d) independently powering each RA lamp; (e) independently powering each laser; (f) powering the x-ray source; and (g) subjecting the nanoporous carbon powder to harmonic electromagnetic resonance in ultramicropores of the nanoporous carbon powder to instantiate the fluid (preferably gaseous) or solid chemical reactant in a nanopore. The invention further includes a fluid (preferably gaseous) or solid chemical reactant by the aforesaid process.

The invention can also include a process for producing a chemical reactant comprising the steps of:
(a) Adding a feed gas to an electromagnetic embedding apparatus comprising:
   (i) a gas line containing the feed gas,
   (ii) at least one E/MEE pencil lamp positioned below the gas line,
   (iii) at least one E/MEE pencil lamp positioned above the gas line and
   (iv) at least one E/MEE pencil lamp positioned to the side of the gas line, wherein each E/MEE pencil lamp is independently rotatably mounted, located along the length of the gas line;
   (v) a power source operably connected to each pencil lamp, and
   (vi) a central processing unit configured to independently control powering each E/MEE pencil lamp and a rotation position of each E/MEE pencil lamp;
(b) powering each pencil lamp, thereby subjecting the feed gas to electromagnetic radiation; optionally rotating one or more lamps;
(c) directing the feed gas from step (b) to a reactor assembly comprising:
   (i) a gas inlet and one or more gas outlets,
   (ii) a reactor chamber containing a nanoporous carbon disposed within a cup and, optionally, covered with a cap,
   (iii) a first porous frit defining a floor of the reactor chamber disposed within the cup,
   (iv) a second porous frit defining the ceiling of the reactor chamber and disposed below the cap; wherein each porous frit has a porosity that is sufficient to allow a gas to permeate into the reactor chamber and contain a nanoporous carbon,
   (v) a reactor head space disposed above the reactor cap, and
   (vi) at least one RA coil surrounding the reactor chamber and/or reactor head space operably connected to a power supply, wherein the computer processing unit is configured to control the power supply to the RA coil;
(d) powering each RA to a first electromagnetic energy level;
(e) subjecting the nanoporous carbon powder to harmonic patterning to instantiate product compositions; and
(f) collecting the chemical reactant from the product compositions.

The invention further includes a fluid (preferably gaseous) or solid chemical reactant produced by the aforesaid process. In embodiments, the chemical reactant is a fuel substance. In embodiments, the chemical reactant comprises a fluid (preferably gaseous) selected from the group consisting of hydrogen (H₂), carbon (C), carbon monoxide (CO), ammonia (NH₃), a substituted or unsubstituted hydrocarbon, a hydrocarbon derivative, and a carbohydrate. In embodiments, the chemical reactant comprises a substituted or unsubstituted hydrocarbon selected from the group consisting of alkanes, cycloalkanes alkenes, alkynes, and substituted or unsubstituted aromatic hydrocarbons, and can comprise a C₁-C₄ alkane, a C₅-C₈ alkane, a C₉-C₁₆ alkane, or an alkane containing 17 or more carbon atoms. In embodiments, the chemical reactant comprises an alcohol or a nitroalkane. In embodiments, the chemical reactant comprises a suitably combustible material.

The invention further includes engines, such as internal combustion engines or otherwise, energized by combustion of a fuel, comprising:
(a) a set of one or more RAs that produces the fuel;
(b) a fuel intake system in fluid communication with the set of one or more RAs and further in fluid communication with a combustion chamber, wherein the fuel intake delivers the fuel into the combustion chamber;
(c) an oxidant delivery system in fluid communication with the combustion chamber, wherein the oxidant delivery system delivers an oxidizing agent into the combustion chamber;
(d) a control system operatively coupled to the fuel intake system and the oxidant delivery system, wherein the control system regulates delivery of a preselected fuel amount and a preselected oxidizing agent amount into the combustion chamber, and wherein the control system triggers an ignition of the fuel and the oxidizing agent when the preselected fuel amount and the preselected oxidizing agent amount are present in the combustion chamber; and
(e) an ignition system within the combustion chamber, triggered by the control system, that ignites the fuel and the oxidizing agent to produce combustion of the fuel, wherein the combustion of the fuel produces energy that energizes the engine.

In embodiments, the fuel comprises hydrogen. In embodiments, the set of one or more RAs comprises a plurality of RAs. In embodiments, the oxidizing agent enters the oxidant delivery system from a feed gas line or from ambient atmosphere, and the oxidizing agent can comprise oxygen or a halogen molecule. In embodiments, the engine can further comprise an auxiliary set of RAs that produces the oxidizing agent, wherein the auxiliary set of RAs is in fluid communication with the oxidant delivery system, and wherein the auxiliary set of RAs produces at least a portion of the preselected oxidizing agent amount in the combustion chamber used for combustion. In embodiments, the engine further comprises an exhaust system, wherein the exhaust system expels byproducts of combustion from the combustion chamber.

In embodiments, the invention includes internal combustion engines comprising a first set of one or more reactor assemblies to instantiate a fuel for the engine; a fuel delivery system in fluid communication with the one or more reactor assemblies and further in fluid communication with a combustion chamber, wherein the fuel delivery system delivers the fuel produced by the one or more reactor assemblies into the combustion chamber; an oxidant delivery system in fluid communication with the combustion chamber, wherein the oxidant delivery system delivers an oxidizing agent into the combustion chamber to mix with the fuel therein to create a fuel mixture; an ignition system operatively coupled to the combustion chamber, wherein the ignition system ignites the fuel mixture within the combustion chamber to produce a combustion, and wherein the combustion produces a gaseous combustion product that imparts a force to an engine component to produce work; and an outlet conduit in fluid communication with the combustion chamber for removal of the gaseous combustion product from the combustion chamber following combustion. The internal combustion engine can be configured as a continuous combustion engine or as an intermittent combustion engine. The internal combustion engine can be a reciprocating engine or a rotary engine. In embodiments, the fuel can comprise hydrogen or consist essentially of hydrogen. In embodiments, the oxidant delivery system is in fluid communication with a second set of one or more reactor assemblies, and wherein the second set of one or more reactor assemblies instantiates the oxidizing agent. The oxidizing agent can comprise oxygen or consist essentially of oxygen. The engine component of the internal combustion engine can be an internal engine component or an external engine component and can be selected from the group consisting of a piston, a rotor, a nozzle, and a set of turbine blades, and the set of turbine blades can power a rotation of a rotary shaft. In embodiments, the work produced comprises propelling a vehicle or carrying out a stationary function, and the stationary function can be selected from the group consisting of pumping, grinding, compressing, mixing, moving an object from one position to another, generating electricity, and powering a machine. In embodiments, the gaseous combustion product comprises a rapidly expanding gas, and the engine component is an external engine component, and the outlet conduit directs the rapidly expanding gas to impart a force to the external engine component to produce the work.

In embodiments, the invention includes external combustion engines comprising a first set of one or more reactor assemblies to instantiate a fuel for the engine; a fuel delivery system in fluid communication with the one or more reactor assemblies and further in fluid communication with a combustion chamber, wherein the fuel delivery system delivers the fuel produced by the one or more reactor assemblies into the combustion chamber; an oxidant delivery system in fluid communication with the combustion chamber, wherein the oxidant delivery system delivers an oxidizing agent into the combustion chamber to mix with the fuel therein to create a fuel mixture; an ignition system operatively coupled to the combustion chamber, wherein the ignition system ignites the fuel mixture within the combustion chamber to produce a combustion, and wherein the combustion forms gaseous combustion products and produces energy that is transferred to a working fluid (i.e., a liquid, or a gas, or both, for example in a dual-phase system that uses a phase transition from liquid to gas to convert the combustion energy into usable work) in a separate compartment to produce work; and an outlet conduit in fluid communication with the combustion chamber for removal of the gaseous combustion products from the combustion chamber following combustion. In embodiments, the fuel comprises hydrogen or the fuel consists essentially of hydrogen. In embodiments, the oxidant delivery system is in fluid communication with a second set of one or more reactor assemblies, and wherein the second set of one or more reactor assemblies instantiates the oxidizing agent. In embodiments, the oxidant delivery system is in fluid communication with a second set of one or more reactor assemblies, and wherein the second set of one or more reactor assemblies instantiate the oxidizing agent. In embodiments, the oxidizing agent comprises oxygen or the oxidizing agent consists essentially of oxygen. In embodiments, the energy produced is heat energy. In embodiments, the working fluid is selected from the group consisting of water, air, sulfur dioxide, fluorocarbons including without limitation chlorofluorocarbons and hydrochlorofluorocarbons, hydrocarbons including without limitation C₁-C₅ alkanes, noble gases, ammonia, and liquid metals. In embodiments, the working fluid can be compressible or incompressible.

In embodiments, the invention includes a process for energizing an engine, comprising:
(a) producing a fuel for the engine, wherein the step of producing comprises the following steps:
   (i) adding a feed gas to an electromagnetic embedding apparatus:
   (ii) exposing the feed gas to at least one E/MEE light source;
   (iii) directing the feed gas from step (ii) to a reactor assembly comprising:
      a gas inlet and one or more gas outlets;
      a reactor chamber containing a nanoporous carbon disposed within a cup and, optionally, covered with a cap;
      a first porous frit defining a floor of the reactor chamber disposed within the cup,
      a second porous frit defining the ceiling of the reactor chamber; wherein each porous frit has a porosity that is sufficient to allow a gas to permeate into the reactor chamber;
      a reactor head space disposed above the reactor chamber;
      at least one RA coil surrounding the reactor chamber and/or reactor head space operably connected to a power supply, wherein the computer processing unit is configured to control the power supply to the RA coil;
   (iv) subjecting the nanoporous carbon powder to harmonic patterning to instantiate a product fluid comprising the fuel; and
   (v) collecting the product fluid comprising the fuel;
(b) delivering the fuel into a combustion chamber of the engine;
(c) delivering an oxidant into the combustion chamber to mix with the fuel, thereby forming a combustible fuel mixture; and
(d) igniting the combustible fuel mixture, thereby creating energy to energize the engine.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a perspective view of an E/MEE of the invention.

FIGS. 2A and 2C show reactor assembly components. FIG. 2B is an expanded view of the reactor assembly components of FIG. 2A.

FIG. 3A, FIG. 3B, FIG. 3C, FIG. 3D and FIG. 3E provides five views of coils which can be used in a reactor assembly.

FIG. 4A is a perspective view of an E/MEE of the invention used in carbon pretreatment.

FIG. 4B shows reactor assembly components.

FIG. 5A illustrates one conformation for a standard coil. FIG. 5B illustrates one conformation for a reverse field coil.

FIGS. 6A and 6B are illustrations of two examples of two composite reactor assemblies.

FIG. 6A illustrates a Composite Reactor with a copper body, carbon graphite cup and a carbon graphite cap and a metal foil boundary. FIG. 6B illustrates a Composite Reactor with a carbon graphite body and cap and metal foil boundary.

FIGS. 7A-7I illustrate various reactor assembly views according to the invention.

FIGS. 8A-8C are illustrations of reactor variations.

FIG. 9 is a diagram of an exemplary system comprising a reactor assembly.

FIG. 10 is a more detailed block diagram of the system illustrated in FIG. 9.

FIG. 11 is a block diagram of an exemplary internal combustion engine system.

FIG. 12 is a block diagram of an exemplary external combustion engine system.

FIG. 13 is a block diagram of an exemplary gas turbine engine system.

### DETAILED DESCRIPTION

The invention relates to methods of instantiating fuels (a type of “chemical reactants”) in nanoporous carbon powders. As used herein, the term “fuel” refers to a chemical substance that reacts with other chemical substances to release energy that is used for work. Chemical reactants produced by the methods and apparatuses disclosed herein can be formed as fluids (preferably gases), solids, or other states of matter.

The invention involves the production of a chemical reactant to be employed as a fuel substance, using methods comprising the steps of contacting a bed comprising a nanoporous carbon powder with a feed gas composition, and optionally an electromagnetically activated gas, while applying electromagnetic radiation to the nanoporous carbon powder for a time sufficient to cause instantiation within and/or from carbon nanopores. The process results in a product composition comprising a chemical reactant substantially distinct from the feed gas composition. The processes of the invention have broad applicability in producing chemical reactants useful as fuels. Such fuels can be utilized for producing energy and/or for producing other valuable substances.

The invention relates to the discovery that carbon matrices can be used to instantiate, or filter, or isolate, or extract, or nucleate, a variety of substances, for example producing nano-deposits, nanostructures, nanowires and nuggets comprising metals or non-metals, by employing processes that include the application of electromagnetic radiation, directly and/or indirectly, to gases, nano-porous carbon, or compositions and combinations thereof, thereby pre-treating these materials, and thereafter exposing a carbon matrix to pre-treated gas in an apparatus to cause metal or non-metal instantiation, nucleation, growth and/or deposition within the carbon matrix.

In more detail, the invention relates to methods of instantiating chemical substances in any form, whether fluid (preferably gaseous), solid, or other. In embodiments, the invention produces metals and non-metals in nanoporous carbon matrices, through processes comprising the steps of contacting a bed comprising nanoporous carbon with an activated gas while applying electromagnetic radiation to the nanoporous carbon for a time sufficient to cause instantiation, including but not limited to nucleation, growth deposition and/or agglomeration, of elemental metal or non-metal nanoparticles within and/or from carbon nanopores and nano-pore networks and matrices. Such processes result in nanoporous carbon compositions or matrices characterized by elemental metals and/or non-metals deposited within carbon nanopores and agglomerated elemental nanoparticles, creating elemental metal nuggets, nanonuggets, nanowires and other macrostructures that can be easily separated from the nanoporous carbon. In embodiments, these processes can produce elemental metal composition and macrostructures; in embodiments, the nanoporous carbon composition can also comprise non-metal nanostructures and/or macrostructures. In embodiments, the processes can instantiate, or filter, or isolate, or extract, or nucleate materials containing carbon, oxygen, nitrogen, sulfur, phosphorous, selenium, hydrogen, and/or halides (e.g., F, Cl, Br and I). Nanoporous carbon compositions further comprising metal oxides, nitrides, and sulfides such as copper oxide, molybdenum sulfide, aluminum nitride have been identified. Therefore, small inorganic molecules or compounds (e.g., molecules comprising 2, 3, 4, 5, 6, 7, 8, 9 or 10 or 25 atoms) can be instantiated, or filtered, or isolated, or extracted, or nucleated, using the processes disclosed herein. Examples of such small molecules include carbides, oxides, nitrides, sulfides, phosphides, halides, carbonyls, hydroxides, hydrates including water, clathrates, clathrate hydrates, and metal organic frameworks. In embodiments, the processes disclosed herein produce small molecules or other materials useful as fuels. In embodiments, such fuels comprise a fluid (preferably gaseous) selected from the group consisting of hydrogen (H₂), carbon (C), carbon monoxide (CO), ammonia (NH₃), a substituted or unsubstituted hydrocarbon, a hydrocarbon derivative, and a carbohydrate. In embodiments, the chemical reactant comprises a substituted or unsubstituted hydrocarbon selected from the group consisting of alkanes, cycloalkanes alkenes, alkynes, and substituted or unsubstituted aromatic hydrocarbons, and can comprise a C₁-C₄ alkane, a C₅-C₈ alkane, a C₉-C₁₆ alkane, or an alkane containing 17 or more carbon atoms.

### 1. Nanoporous Carbon Powders and Compositions

a. Nanoporous Carbon Powders

Nanoporous carbon powders or nanostructured porous carbons can be used in the processes and methods of the invention. Nanoporous carbon powders or nanostructured porous carbons are also referred to herein as “starting material” or “charge material”. The carbon powder preferably provides a surface and porosity (e.g., ultra-microporosity) that enhances metal deposition, including deposit, instantiation and growth. Preferred carbon powders include activated carbon, engineered carbon, graphite, and graphene. For example, carbon materials that can be used herein include graphene foams, fibers, nanorods, nanotubes, fullerenes, flakes, carbon black, acetylene black, mesophase carbon particles, microbeads and, grains. The term “powder” is intended to define discrete fine, particles or grains. The powder can be dry and flowable or it can be humidified and caked, such as a cake that can be broken apart with agitation. Although powders are preferred, the invention contemplates substituting larger carbon materials, such as bricks and rods including larger porous carbon blocks and materials, for powders in the processes of the invention.

The examples used herein typically describe highly purified forms of carbon, such as >99.995% wt. pure carbon (metals basis). Highly purified forms of carbon are exemplified for proof of principle, quality control and to ensure that the results described herein are not the result of cross-contamination or diffusion within the carbon source. However, it is contemplated that carbon materials of less purity can also be used. Thus, the carbon powder can comprise at least about 95% wt. carbon, such as at least about 96%, 97%, 98% or 99% wt. carbon. In a preferred embodiment, the carbon powder can be at least 99.9%, 99.99% or 99.999% wt. carbon. In each instance, purity can be determined on either an ash basis or on a metal basis. In another preferred embodiment, the carbon powder is a blend of different carbon types and forms. In one embodiment, the carbon bed is comprised of a blend of different nano-engineered porous carbon forms. Carbon powders can comprise dopants.

The carbon powder preferably comprises microparticles. The volume median geometric particle size of preferred carbon powders can be between less than about 1 μm and 5 mm or more. Preferred carbon powders can be between about 1 μm and 500 μm, such as between about 5 μm and 200 μm. Preferred carbon powders used in the exemplification had median diameters between about 7 μm and 13 μm and about 30 μm and 150 μm.

The dispersity of the carbon particle size can improve the quality of the products. It is convenient to use a carbon material that is homogeneous in size or monodisperse. Thus, a preferred carbon is characterized by a polydispersity index of between about 0.5 and 1.5, such as between about 0.6 and 1.4, about 0.7 and 1.3, about 0.8 and 1.2, or between about 0.9 and 1.1. The polydispersity index (or PDI) is the ratio of the mass mean diameter and number average diameter of a particle population. Carbon materials characterized by a bimodal particle size can offer improved gas flow in the reactor.

The carbon powder is preferably porous. The pores, or cavities, residing within the carbon particles can be macropores, micropores, nanopores and/or ultra-micropores. A pore can include defects in electron distribution, compared to graphene, often caused by changes in morphology due to holes, fissures or crevices, corners, edges, swelling, or changes in surface chemistry, such as the addition of chemical moieties or surface groups, etc. For example, variation in the spaces that may arise between layers of carbon sheets, fullerenes or nanotubes are contemplated. It is believed that instantiation preferentially occurs at or within a pore or defect-containing pore and the nature of the surface characteristics can impact instantiation. For example, Micromeritics enhanced pore distribution analysis (e.g., ISO 15901-3) can be used to characterize the carbon. It is preferred that the carbon powder is nanoporous. A “nanoporous carbon powder” is defined herein as a carbon powder characterized by nanopores having a pore dimension (e.g., width or diameter) of less than 100 nm. For example, IUPAC subdivides nanoporous materials as microporous (having pore diameters between 0.2 and 2 nm), mesoporous materials (having pore diameters between 2 and 50 nm) and macroporous materials (having pore diameters greater than 50 nm). Ultramicropores are defined herein as having pore diameters of less than about 1 nm.

Uniformity in pore size and/or geometry is also desirable. For example, ultramicropores in preferred carbon materials (e.g., powders) account for at least about 10% of the total porosity, such as at least about 20%, at least about 30%, at least about 40%, at least about 50%, at least about 60%, at least about 70%, at least about 80%, or at least about 90%. Preferred carbon materials (e.g., powders) are characterized with a significant number, prevalence or concentration of ultra-micropores having the same diameter, thereby providing predictable electromagnetic harmonic resonances and/or standing wave forms within the pores, cavities, and gaps. The word “diameter” in this context is not intended to require a spherical geometry of a pore but is intended to embrace a dimension(s) or other characteristic distances between surfaces. Accordingly, preferred carbon materials (e.g., powders) are characterized by a porosity (e.g., nanopores or ultramicropores) of the same diameter account for at least about 10% of the total porosity, such as at least about 20%, at least about 30%, at least about 40%, at least about 50%, at least about 60%, at least about 70%, at least about 80%, or at least about 90%.

Measuring adsorption isotherm of a material can be useful to characterize the surface area, porosity, e.g., external porosity, of the carbon material. Carbon powders having a surface area between about 1 m²/g and 3000 m²/g are particularly preferred. Carbon powders having an ultramicropore surface area of at least about 50 m²/g, preferably at least about 300 m²/g, at least about 400 m²/g, at least about 500 m²/g or higher are particularly preferred. Activated or engineered carbons, and other quality carbon sources, can be obtained with a surface area specification. Surface area can be independently measured by BET surface adsorption technique.

Surface area correlation with metal deposition was explored in a number of experiments. Classical pore surface area measurements, using Micromeritics BET surface area analytical technique with nitrogen gas at 77K (−196.15° C.) did not reveal a substantial correlation in the deposition of metal elements at ≥5σ confidence level, or probability of coincidence. However, a correlation with ultramicropores (pores having a dimension or diameter of less than 1 nm) was observed. Without being bound by theory, instantiation is believed to be correlated to resonating cavity features of the ultra-micropore and ultramicropore network such as the distance between surfaces or walls. Features of the ultramicropore, can be predicted from ultramicropore diameter as measured by BET, augmented by density function theory (DFT) models, for example. With the aid of machine learning, more precise relationships between ultramicropore size, distribution, turbostratic features, wall separation and diameter and elemental metal nucleation can be established.

Carbon materials and powders can be obtained from numerous commercial providers. MSP-20X and MSC-30 are high surface area alkali activated carbon materials with nominal surface areas of 2,000-2,500 m²/g and >3,000 m²/g and median diameters of 7-13 μm and 60-150 μm respectively (Kansai Coke & Chemicals Co). Norit GSX is a steam-washed activated carbon obtained from Alfa Aesar. The purified carbon forms used in the experimental section all exceed ≥99.998 wt % C (metals basis).

Modifying the surface chemistry of the carbon can also be desirable. For example, improved performance was observed when conditioning the carbon with an acid or base. Contacting the carbon with a dilute acid solution selected from the group consisting of HCl, HF, HBr, HI, sulfuric acid, phosphoric acid, carbonic acid, and nitric acid followed by washing with water (such as deionized water) can be beneficial. The acid is preferably in an amount less than about 30%, less than about 25%, less than about 20% less than about 15%, less than about 10%, or less than about 5%, preferably less than or equal to 1% vol. The preferred acid for an acid wash is an acid having a pKa of less than about 3, such as less than about 2. After washing, it can be beneficial to subject the carbon to a blanket of a gas, such as helium, hydrogen or mixtures thereof. Alternative gases include, without limitation, carbon monoxide, carbon dioxide, nitrogen, argon, neon, krypton, helium, ammonia and hydrogen. The carbon can also be exposed to a base, such as KOH before or after an acid treatment.

Controlling residual water content in the carbon which may include moisture can improve performance. For example, the carbon material can be placed in an oven at a temperature of at least about 100° C., preferably at least about 125° C., such as between 125° C. and 300° C. for at least 30 minutes such as about an hour. The oven can be at ambient or negative pressure, such as under a vacuum. Alternatively, the carbon material can be placed in an oven with high vacuum at a temperature of at least about 250° C., preferably at least about 350° C., for at least one hour, such as at least 2, 3, 4, 5, or 6 hours. Alternatively, the carbon material can be placed in an oven with high vacuum at a temperature of at least about 700° C., preferably at least about 850° C., for at least one hour, such as at least 2, 3, 4, 5, or 6 hours. Alternatively, the water or moisture can be removed by vacuum or lyophilization without the application of substantial heat. Preferably, the water, or moisture, level of the carbon is less than about 35%, 30%, 25%, 20%, 15%, 10%, 5%, such as less than about 2%, by weight carbon. In other embodiments, the carbon can be exposed to a specific relative humidity (RH) such as 0.5%, 1%, 2%, 5%, 12% RH or 40% RH or 70% RH or 80% RH or 90% RH, for example, at 22° C.

Pre-treatment of the carbon material can be selected from one or more, including all, the steps of purification, humidification, activation, acidification, washing, hydrogenation, drying, chemistry modification (organic and inorganic), and blending. For example, the carbon material can be reduced, protonated or oxidized. The order of the steps can be as described, or two or more steps can be conducted in a different order.

For example, MSP-20X was exposed to an alkali (C:KOH at a molar ratio of 1:0.8), activated at 700° C. for 2 hours, washed with acid and then hydrogenated to form MSP-20X Lots 1000 when washed with HCl and 105 when washed with HNO3. MSP-20X was washed with acid and then hydrogenated to form MSP-20X Lots 1012 when washed with HCl and 1013 when washed with HNO3. Activated carbon powder developed for the storage of hydrogen was HCl acid washed, then subjected to HNO3 washing and hydrogenation to form APKI lots 1001 and 1002, as substantially described in Yuan, J. Phys. Chem. B20081124614345-14357. Poly(ether ether ketone) (PEEK, Victrex 450P) and poly(ether imide) (PEI, Ultem® 1000) was supplied by thermally oxidized in static air at 320° C. for 15 h, and carbonized at the temperature range of 550-1100° C. in nitrogen atmosphere, at the carbon yield of 50-60 wt %. These carbons were then activated by the following procedures: (1) grind the carbonized polymer with KOH at KOH/carbon˜1/1-1/6 (w/w), in the presence of alcohol, to form a fine paste; (2) heat the paste to 600-850° C. in nitrogen atmosphere for 2 h; (3) wash and rinse with DI water and dry in vacuum oven. PEEK/PEI (50/50 wt) blend was kindly supplied by PoroGen, Inc. Likewise, the acid washing sequence of Lots 1001 and 1002 was reversed to form APKI lots 1003 and 1004. Universal grade, natural graphite, ˜200 mesh was purchased from Alfa Aesar, product number 40799. Graphite lots R and Z were HCl washed and hydrogenated to form R lot 1006 and Z lot 1008, respectively. Alfa Aesar graphite R and Z were nitric acid washed and hydrogenated to form R lot 1007 and Z lot 1009, respectively. MSC-30 (Kansai Coke and Chemicals) was acid washed and then hydrogenated to form MSC30 lots 1010 when washed with HCl and 1011 when washed with HNO3. MSC-30 was exposed to an alkali (C:KOH at a molar ratio of 1:0.8), activated at 700° C. for 2 hours, HCl or nitric acid washed and then hydrogenated to form MSC-30 lots 1014 (HCl washed) and 1015 (HNO3 washed), respectively. MSP-20X, MSC-30, Norit GSX and Alfa Aesar R were subjected to purification by MWI, Inc. for MSP-20X Lots 2000 and 2004, MSC-30 Lots 2001, 2006 and 2008, Norit GSX Lots 2005 and 2007, and Alfa Aesar R Lot 2009 respectively. MSP-20X Lot 2000 and MSC-30 2001 were HCl washed and hydrogenated to form MSP-20X Lot 2002 and MSC-30 Lot 2003, respectively. Alfa Aesar R was washed with 1%, 5%, 10%, 15%, 20%, 25%, and 30% HCl (vol.) and then hydrogenated to form R Lot Graphite n % vol HCl, respectively. Purified MSP-20X (Lot 2006) was similarly washed by HCl, nitric acid, HF or H₂SO₄ to form MSP-20X 1% HCl, MSP-20X 1% HNO₃, MSP-20X 0.4% HF, MSP-20X 0.55% H₂SO₄ (Lot 1044), respectively. Purified Norit GSX (Lot 2007) was similarly washed by nitric acid, HF or H₂SO₄ to form Norit GSX 1% HNO₃ (Lot 1045), Norit-GSX 0.4% HF, Norit-GSX 0.55% H₂SO₄, respectively. Purified MSC30 (Lot 2008) was similarly washed by HCl and H₂SO₄ to form MSC30 1% HCl, and MSC30 5% H₂SO₄. Purified MSP20X (Lot 2006), Norit GSX (Lot 2007) and MSC30 (Lot 2008) were hydrogenated. Purified MSP-20X, Norit GSX and MSC30 were washed with 1% HCl using methanol as a wetting agent. APKI-S-108 Lots 1021-1024 were recycled. The Ref-X Blend is a 40% Alfa Aesar R:60% MSP-20X (lot 2006) 850° C. desorb then CO₂ exposure at 138 kPa (20 psi) for 5 days.

It is preferred to degas the nanoporous carbon powder can be degassed prior to initiating the process. For example, the nanoporous carbon powder can be degassed by subjecting the powder to a vacuum. A range of vacuums can be used, with or without elevated temperatures. It has been found that applying a vacuum of about 10⁻² torr to 10⁻⁶ torr was sufficient. The powder can be degassed prior to charging the powder into the reactor chamber. Preferably the powder can be degassed after the powder is charged into the reactor chamber. In the examples below, which are non-limiting, the carbon powder is charged into the reactor chamber, placed into the reactor assembly and the entire reactor assembly is subjected to a degassing step by maintaining the reactor assembly under vacuum. The degassing step can be performed at ambient temperature or an elevated temperature. For example, good results were achieved at a temperature of 400° C. Other temperatures can be at least 50° C., such as at least 100° C., at least 150° C., at least 200° C., or at least 300° C. The degassing step can be maintained for at least 30 minutes, such as at least 45 minutes, at least 60 minutes, at least 4 hours, at least 6 hours, at least 12 hours, or at least 24 hours. Degassing the carbon powder ensures that contaminant elements have been removed from the system.

The carbon can be recycled or reused. In recycling the carbon, the carbon can optionally be subjected to an acid wash and/or water removal one or more times. In this embodiment, the carbon can be reused one or more times, such as 2, 3, 4, 5, 10, 15, 20, or about 25 or more times. The carbon can also be replenished in whole or in part. It has been discovered that recycling or reusing the carbon can enhance metal nanostructure yields and adjust nucleation characteristics enabling change in element selectivity and resultant distributions. Thus, an aspect of the invention is to practice the method with recycled nanoporous carbon powder, e.g., a nanoporous carbon powder that has been previously subjected to a method of the invention one or more times.

b. Nanoporous Carbon Compositions

The nanoporous carbon compositions produced by the processes described herein possess several surprising and unique qualities. The nanoporosity of the carbon powder is generally retained during processing and can be confirmed, for example, visually with a scanning electron microscope or modeled by BET analysis. Visual inspection of the powder can identify the presence of elemental nanostructures residing within and surrounding the nanopores. The nanostructures can be elemental metals or non-metals. Visual inspection of the powder can also identify the presence of elemental macrostructures residing within and surrounding the nanopores. The macrostructures can be elemental metals or nonmetals, and can contain interstitial and/or internal carbon, as generally described by Inventor Nagel in U.S. Pat. Nos. 10,889,892 and 10,844,483, each of which is incorporated herein by reference in its entirety. Methods for instantiating gases are described in U.S. Ser. No. 63/241,697 by Inventor Nagel, which is incorporated herein by reference in its entirety.

Typically, the porosity of the nanoporous carbon compositions will be at least about 70% of the porosity attributed to ultramicropores of the nanoporous carbon powder starting, or charge, material and having a total void volume that is about 40% or more of the bulk material volume. The pores, or cavities, residing within the carbon particles can be macropores, micropores, nanopores and/or ultra-micropores. A pore can include defects in electron distribution, compared to graphene, often caused by changes in morphology due to holes, fissures or crevices, edges, corners, swelling, dative bonds, or other changes in surface chemistry, such as the addition of chemical moieties or surface groups, etc. For example, the spaces that may arise between layers of carbon sheets, fullerenes, nanotubes, or intercalated carbon are contemplated. It is believed that instantiation preferentially occurs at or within a pore and the nature of the surface characteristics can impact the deposit. For example, Micromeritics enhanced pore distribution analysis (e.g., ISO 15901-3) can be used to characterize the carbon. It is preferred that the carbon powder is nanoporous. Chemical reactant products or product compositions useful as fuels that are produced by the process can be isolated or harvested from nanoporous carbon compositions.

### 2. Methods and Apparatus

Conceptually, the apparatus for baseline experimentation can be broken into two primary areas: Gas Processing and Reactor Assembly.

a. Gas Processing:

The gas processing section controls gas composition and flow rate, with the optional embedding of electromagnetic (e.g., light) information or electromagnetic gas pre-treatment to the reactor.

The invention includes an electromagnetic embedding enclosure (E/MEE or EMEE), or apparatus, for processing a gas (feed gas or first gas composition, used interchangeably herein) comprising or consisting of:
a central processing unit and power supply;
one or more gas supplies;
a housing having a housing inlet and housing outlet;
an upstream gas line that is in fluid connection with each gas supply and the housing inlet;
an internal gas line in fluid connection with the housing inlet and housing outlet; a downstream gas line in fluid connection with the housing outlet;
at least one pencil lamp positioned below the internal gas line, at least one pencil lamp positioned above the internal gas line and/or at least one pencil lamp positioned to the side of the internal gas line;
an optional short-wave lamp and/or a long wave lamp; and
an optional coil wrapped around the internal gas line, operably connected to a frequency generator;
wherein each lamp is independently rotatably mounted, located along the length of the internal gas line, and powered by the power supply; and
wherein the central processing unit independently controls powering the frequency generator, if present, and each lamp and the rotation position of each lamp.
   It will be understood that spatial terms, such as “above,” “below”, “floor” and “to the side” are relative to a particular specified object or other point of reference. Thus, a lamp, for example, that is positioned “above” a gas line takes its orientation from the gas line as reference point; if the gas line is positioned “above” the floor of the room in which the apparatus is housed, the lamp positioned “above” the gas line is also “above” the floor. A lamp that is positioned “above” the floor does not have a designated position with respect to a gas line that is also positioned “above” the floor unless the lamp's position is also specified with reference to said gas line. In other words, if one were to draw X, Y and Z axes through a particular assembly or apparatus, the terms “above,” “below” and “to the side” is intended to only refer to positions relative to such axes and not as the axes would be drawn relative to the space or room in which the assembly resides.

Feed gases can preferably be research grade or high purity gases, for example, as delivered via one or more gas supplies, such as a compressed gas cylinder. Examples of gases that can be used include, for example and without limitation, air, oxygen, nitrogen, helium, neon, argon, krypton, xenon, ammonium, carbon monoxide, carbon dioxide and mixtures thereof. Preferred gases include nitrogen, helium, argon, carbon monoxide, carbon dioxide and mixtures thereof. Nitrogen, air and helium are preferred. In certain of the examples below, a highly purified nitrogen gas was used. The use of highly purified nitrogen gas facilitated product gas analysis. The feed gas can be added continuously or discontinuously, throughout the process. The gases can be free of metal salts and vaporized metals.

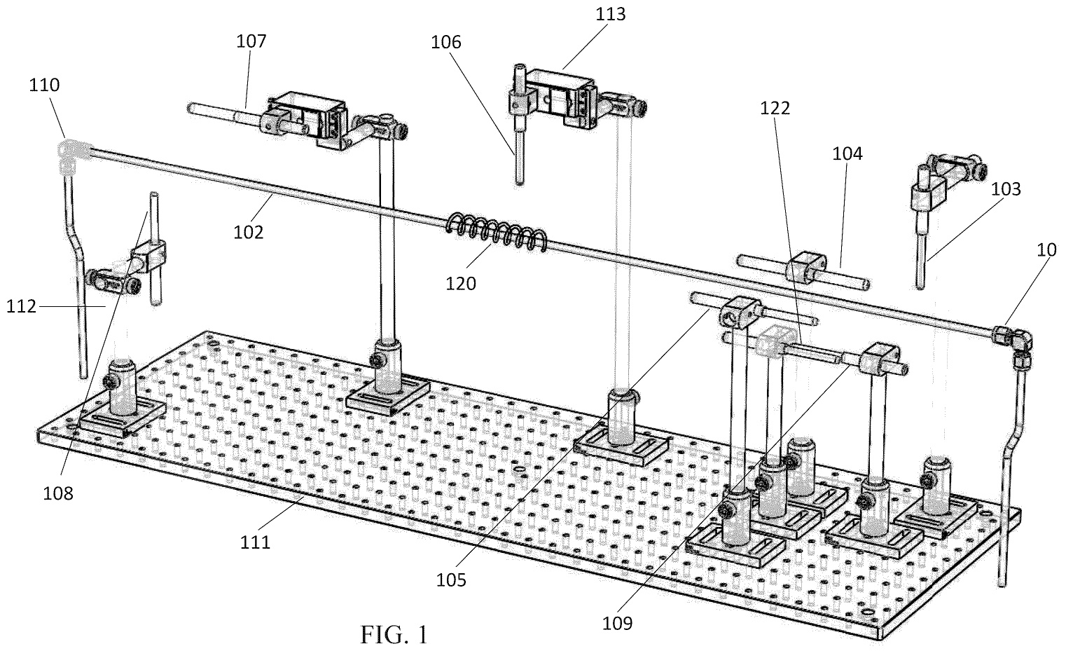

One or more gases (e.g., 2, 3, 4, 5, or more gases) can optionally pass through a gas manifold comprising mass flow meters to produce a feed gas composition, also called the reactor feed gas. The reactor feed gas may then either by-pass an electromagnetic (EM) embedding enclosure (E/MEE) or pass through one or more E/MEEs. The E/MEE exposes the reactor feed gas to various electromagnetic field (EMF) sources. Flow rates, compositions, and residence times can be controlled. The rate of flow of the reactor feed gas can be between 0.01 standard liters per minute (SLPM) and 10 SLPM, or 100 SLPM or more. A constant flow of gas can maintain a purged environment within the reactor. The schematics shown in FIG. 1 depicts a flow path for the gases through a sample E/MEE. The sample E/MEE comprises a series of lights and coils that can optionally expose the reactor feed gas to EM radiation. EMF sources within the E/MEE can be energized simultaneously or in sequence or a combination thereof.

FIG. 1 is an illustration of an E/MEE of the invention for the production of gaseous chemical reactants. Gas enters the E/MEE via the inlet 101, or entrance, in line 102 and exits at the outlet, or exit, 110. The inlet 101 and outlet 110 may optionally have valves.

Line 102 can be made of a transparent or translucent material (glass is preferred) and/or an opaque or non-translucent material, such as stainless steel or non-translucent plastic (such as TYGON® manufactured by Saint-Gobain Performance Plastics) or a combination thereof. Using an opaque material can reduce or eliminate electromagnetic exposure to the gas as the gas resides within the line. The length of line 102 can be between 50 cm and 5 meters or longer. The inner diameter of line 102 can be between 2 mm and 25 cm or more. Line 102 can be supported on and/or enclosed within a housing or substrate 111, such as one or more plates, with one or more supports 112. For example, substrate 111 can be configured as a plane or floor, pipe or box. Where the substrate is a box, the box can be characterized by a floor, a ceiling and side walls. The box can be closed to and/or insulated from ambient EM radiation, such as ambient light.

One or more lamps (such as 2, 3, 4, 5, 6, 7, 8, 9, 10 lamps or more) can be configured within the E/MEE. Lamps (numbered individually) are preferably pencil lamps characterized by an elongated tube with a longitudinal axis. The pencil lamps can independently be placed such that their longitudinal axes are (i) parallel to the line 102, (ii) disposed radially in a vertical plane to the line 102, or (iii) perpendicular to the plane created along the longitudinal axis of the line 102 or along the vertical axis of the line 102.

Each lamp can, independently, be fixed in its orientation by a support 112. Each lamp can, independently, be affixed to a pivot 113 to permit rotation from a first position. For example, the lamps can be rotated between about 0 and 360 degrees, such as about 45, 90, 135, 180, 225 or 270 degrees, preferably about 90 degrees relative to a first position. The rotation can be with respect to the x, y, and/or z axis wherein (i) the x-axis is defined as the axis parallel to the gas line and its vertical plane, (ii) the y-axis defining the axis perpendicular to the gas line and parallel to its horizontal plane, and (iii) the z-axis is defined as the axis perpendicular to the gas line and parallel to its vertical plane.

Referring to the specific pencil lamps within an E/MEE, line 102 is configured along the E/MEE with gas flowing from the inlet 101 and exiting at the outlet 110. Lamp 103, a neon lamp, is first and is shown above line 102 oriented to be along the z-axis and perpendicular to line 102, with the tip of the lamp pointed towards line 102. Lamp 109, a krypton lamp, is shown below line 102 oriented to be parallel to the x-axis, with the tip pointing towards the outlet 110. Lamps 104 and 105, a long wave and short-wave lamp, respectively, are shown parallel to line 102 oriented to be along the x-axis with the tips pointing towards the inlet. Lamp 122, an argon lamp, is shown to be below line 102 oriented to be parallel to the x-axis, with the tip pointing towards the inlet 101 at approximately the same distance from the inlet as lamps 104 and 105. Lamp 106, a neon lamp, is downstream at about the midpoint of the E/MEE, is above line 102 with the tip pointing down. Lamp 107, a xenon lamp, is shown downstream of lamp 106 above line 102, parallel to the x axis of line 102 and points toward the outlet 110. Lamp 108, an argon lamp, is below line 102 and the tip is pointing toward line 102 along the z-axis. Optional coil 120 is wrapped around line 102. Each of these lamps can be independently rotated, for example, 90 degrees along any axis. Each lamp is connected to a power supply or power source to turn on or off the power. Each lamp can be independently rotated 1, 2, 3, 4 or more times during the process. For convenience, each lamp is held by a pivot that can be controlled by a central processing unit, such as a computer programmed to rotate the pivot and provide power to each lamp. For the ease of describing the experimental procedures, each orientation of each lamp is called “position n” wherein n is 0, 1, 2, 3, 4, or more. As the procedure is conducted, each lamp can be powered for specific periods of time at specific amperage(s) and positioned or repositioned.

In the exemplification described below, the initial bulb position for each lamp is described with a degree. A zero-degree (0°) reference point is taken as the 12 o'clock position on the glass pipe when looking down the gas pipe in the direction of intended gas flow (e.g., when looking at the E/MEE exit). The length of the glass pipe or line is taken as the optical length (e.g., in this instance 39 inches). For example, 6 inches from the end is defined as 6 inches from the optical end of pipe.

The lamps can be placed above, below, or to the side (for example, level with the longitudinal axis or a plane parallel to (above or below) the longitudinal axis), for example, of line 102. The lamps can be independently placed between 5 and 100 cm from the center of the line 102 in the vertical plane, as measured from the tip of the lamp to the center of line 102. One or more lamps can be placed in the same vertical plane along line 102, as illustrated by lamps 122, 104, and 105. Two lamps are in the same vertical plane if they (as defined by the tip or base of the lamp) are the same distance from the inlet 101. Preferably, lamp 105 can be placed in a plurality of (e.g., 2, 3, 4, 5 or more) vertical planes along the length of line 102 within the E/MEE. Further, one or more lamps can be placed in the same horizontal plane above, below or through line 102, as shown with lamps 104 and 105. Two lamps are in the same horizontal plane if they (as defined by the tip or base of the lamp) are the same distance from the center of line 102. Preferably, lamps can be placed in a plurality of (e.g., 2, 3, 4, 5 or more) horizontal planes along the length of line 102 within the E/MEE, as generally illustrated.

It is understood that “pencil lamps,” as used herein, are lamps filled with gases or vapor that emit specific, calibrated wavelengths upon excitation of the vapor. For example, pencil lamps include without limitation argon, neon, xenon, and mercury lamps. For example, without limitation, one or a plurality of lamps can be selected from argon, neon, xenon or mercury or a combination thereof. Preferably, at least one lamp from each of argon, neon, xenon and mercury are selected. Wavelengths between 150 nm and 1000 nm can be selected. One example of a pencil lamp is a lamp characterized by an elongated tube having a tip and a base.

Long wave and/or short-wave ultraviolet lamps can also be used. Pencil lamps used in the E/MEE were purchased from VWR™ under the name UVP Pen_Ray® rare gas lamps, or Analytik Jena in the case of the UV short wave lamps.

A power supply is operably connected to independently to each lamp, E/MEE coil, and frequency generator. The power supply can be AC and/or DC.

The E/MEE can be open or enclosed. Where the E/MEE is enclosed, the enclosure is typically opaque and protects the gas from ambient light. Without limitation, the enclosure can be made of a plastic or resin or metal. It can be rectangular or cylindrical. Preferably, the enclosure is characterized by a floor support.

In baseline experimentation the feed gas can by-pass the E/MEE section and are fed directly to the reactor assembly. The energy levels and frequencies provided by the EM sources can vary.

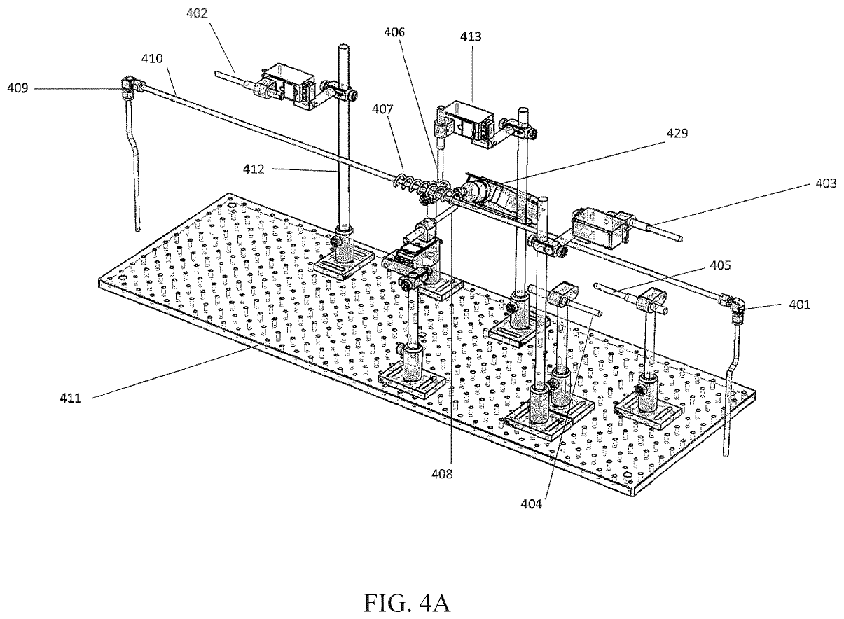

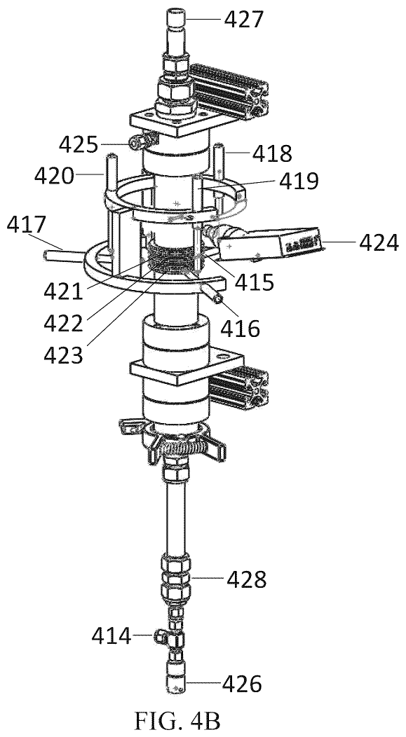

FIG. 4A provides a second illustration of an E/MEE of the invention. Gas enters the E/MEE at inlet 401 and exits at outlet 409 along line 410. Pencil lamp 402 and Pencil lamp 403 are shown parallel to and above line 410 along the vertical plane through line 410 axis. Pencil lamps 404 and 405 are parallel to and below line 410 in the same horizontal plane equidistant from the vertical plane through line 410. Pencil lamp 406 is shown above and perpendicular to line 410, positioned along the z axis. An optional coil 407 is a conductive coil wrapped around line 410. Pencil lamp 408 is shown below and perpendicular to line 410 along the y axis. Substrate 411 provides a base for supports 412. Pivots 413 control the position of each pencil lamp and permit rotation along axis x, y and z. An optional x-ray source 429 is also shown directed towards the coil 407.

The coil 407 is preferably made of conducting material and is connected to a power supply and, optionally, a frequency generator. The coil can comprise copper, aluminum, platinum, silver, rhodium, palladium or other metals or alloys (including braidings, platings and coatings) and can optionally be covered with an insulating coating, such as glyptal. It can be advantageous to use a braid of 1, 2, 3 or more metal wires. The coil can be manufactured from wire typically used in an induction coil and can vary in size and the number of turns. For example, the coil can comprise, 3, 4, 5, 6, 7, 8, 9, 10 or more turns. The inner diameter of the coil can be between 2 cm and 6 cm or more and preferably snugly fits the line 410. An x-ray source 429 can included in the E/MEE. For example, the x-ray source can be directed at line 410 along the line between the inlet 401 and outlet 409. For example, it can be advantageous to direct the x-ray source at coil 407, where present.

b. Reactor Assembly (RA):

The invention further relates to a reactor assembly comprising:
A gas inlet and one or more gas outlets;
A reactor chamber, preferably containing a nanoporous carbon material or powder;
A first porous frit defining a floor of the reactor chamber,
A second porous frit defining the ceiling of the reactor chamber; wherein each porous frit has a porosity that is sufficient to allow a gas to permeate into the reactor chamber and contain a nanoporous carbon material;
An optional reactor cup defining side walls of the reactor chamber;
An optional reactor cap positioned above the second porous frit;
A reactor body disposed below the first porous frit;
A reactor head space disposed above the reactor cap;
An optional foil disposed between the reactor chamber and reactor cup;
One or more coils surrounding the reactor body and/or the reactor chamber operably connected to a power supply and/or frequency generator;
An optional x-ray source configured to expose the reactor head space to x-rays;
One or more optional lasers configured to direct a laser towards a frit and/or through the reactor chamber;
A computer processing unit configured to control the power supply, frequency generator, lamps, lasers and x-ray source, when present.

The invention also includes a reactor assembly comprising:
A gas inlet and one or more gas outlets;
A reactor chamber, preferably containing a nanoporous carbon material;
A first porous frit defining a floor of the reactor chamber,
A second porous frit defining the ceiling of the reactor chamber; wherein each porous frit has a porosity that is sufficient to allow a gas to permeate into the reactor chamber and contain a nanoporous carbon material;
A reactor head space disposed above the reactor cap;
2, 3, 4, 5 or more RA coils surrounding the reactor chamber and/or reactor head space operably connected to an RA frequency generator and power supply;
2, 3, 4, 5 or more pairs of lamps wherein the pairs of lamps are disposed circumferentially around the RA coils and define a space between the pairs of lamps and the RA coils;
An optional x-ray source configured to expose the reactor chamber to x-rays;
One or more optional lasers configured to direct a laser through the reactor chamber; and
A computer processing unit configured to control the power supply, frequency generator and the optional x-ray source and lasers.

As previously described, the terms “above”, “floor” and “ceiling” are intended to describe relational spatial features. “Floors” and “ceilings” are typically opposing sides of a space or volume where the head space is adjacent to the “ceiling” and distal to the “floor,” irrespective of the relational geometry to the room or space in which the apparatus resides. In other words, a “ceiling” represents a boundary wall or plane in an assembly confining a space or volume (generally understood as the “top” boundary of such space or volume), while the “floor” represents a boundary wall or plane opposite the ceiling in the same assembly confining the same space or volume (generally understood as the “bottom” boundary of such space or volume). Rotating the assembly on an axis by, for example, 45, 90 or 180 degrees, for example, does not change the relative position of the two planes or assemblies to each other, and such a rotated assembly can still include references to the ceiling or a floor structure thereof as these structures were identified in the assembly prior to such rotation.

The invention also includes a reactor assembly comprising:
A gas inlet and one or more gas outlets;
A reactor chamber, preferably containing a nanoporous carbon material;
A first porous frit defining a floor of the reactor chamber,
A second porous frit defining the ceiling of the reactor chamber; wherein each porous frit has a porosity that is sufficient to allow a gas to permeate into the reactor chamber and contain a nanoporous carbon material;
A reactor head space disposed above the reactor chamber;
An induction coil surrounding the reactor chamber and/or reactor head space operably connected to a power supply; and
A computer processing unit configured to control the power supply. The reactor chamber can optionally contain a cap and/or cup to contain the carbon material.

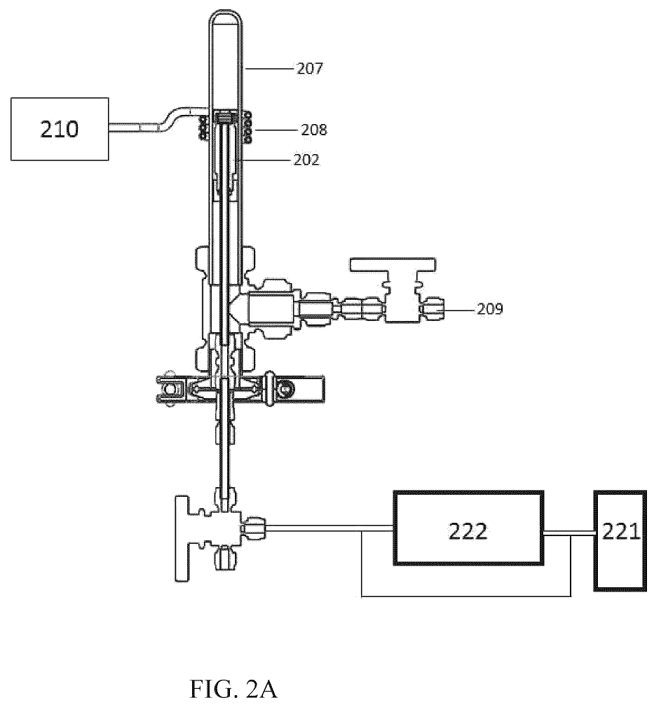

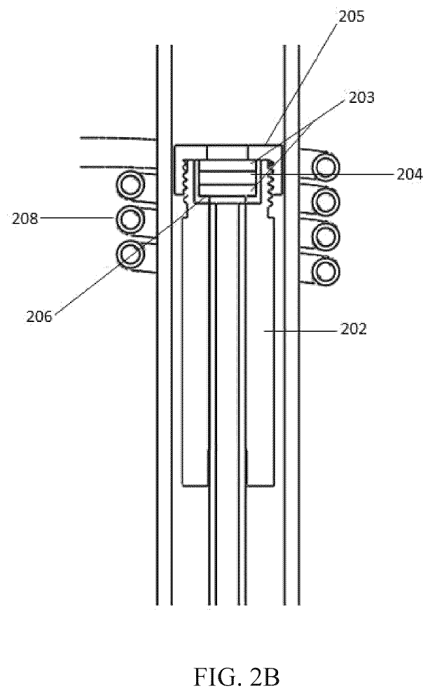

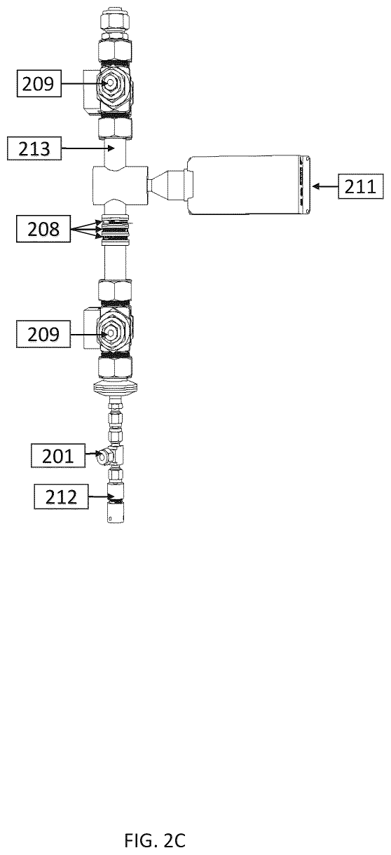

As shown in FIGS. 2A, 2B and 2C, the reactor assembly comprises a reactor body 202 and starting, or charge, material 204 (which is generally a nanoporous carbon powder) and is located downstream of the gas sources 221 and E/MEE 222, as shown in FIG. 2A. As described above, it is possible for reactor feed gas to bypass the E/MEE. The reactor body 202 can be a packed bed tubular micro-reactor surrounded by one or more conducting coils 208, as illustrated in FIG. 2A, FIG. 2B, and FIG. 2C. FIG. 2A and FIG. 2B show cross sections of the reactor assembly. The conducting coil 208 can be manufactured from electrically conducting material, such as, without limitation, copper, aluminum, platinum, silver, rhodium, palladium or other metals or alloys (including braidings, platings and coatings) and can optionally be covered with an insulating coating, such as glyptal. The coil can be manufactured from wire typically used in an induction coil and can vary in size and the number of turns. For example, the coil can comprise 3, 4, 5, 6, 7, 8, 9, 10 or more turns. The inner diameter of the coil can be between 2 cm and 6 cm or more and preferably snugly fits the reactor body containment 207. The wire used can have a diameter of between 5 mm and 2 cm.

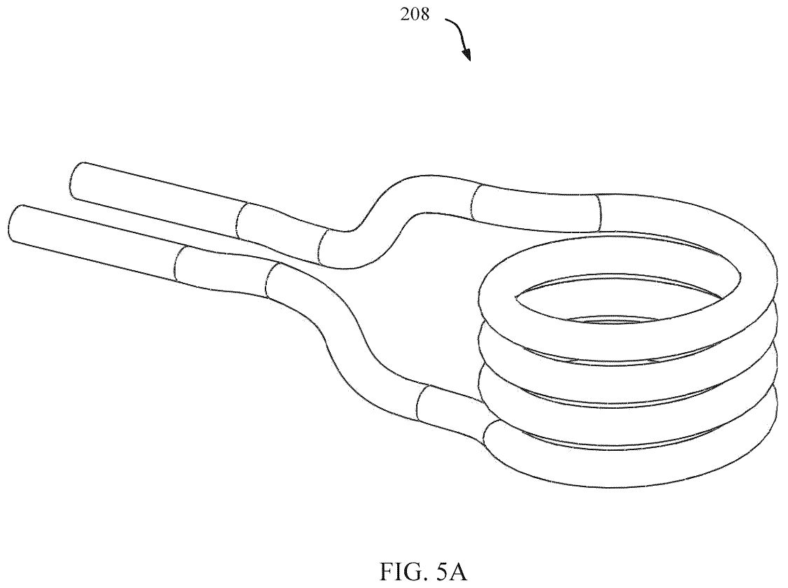

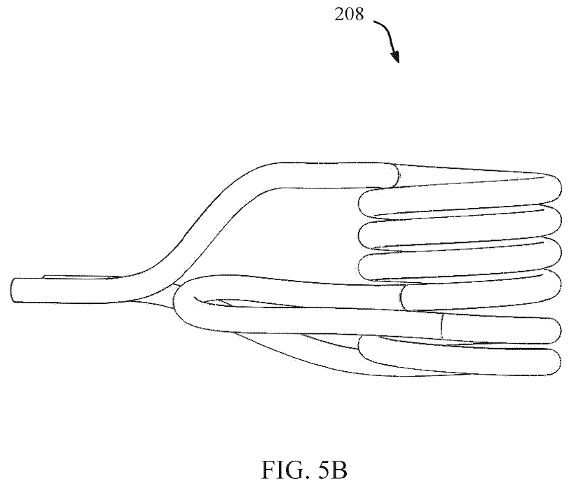

Each conducting coil 208 (or coils) can generate inductive heat and, optionally, a magnetic field. Standard induction coils or reverse field induction coils (coils that have a lower and upper sections connected through an extended arm that allows the sections to be wound in opposite directions, thereby producing opposing magnetic fields) are preferred. The coil 208 can be water-cooled via a heat exchanger. The coil can be connected to a power flange 210, which can be water cooled as well and in turn can connect to a power supply, such as an Ambrell 10 kW 150-400 kHz power supply. In baseline experimentation a standard coil was used with simple copper windings. The windings can form a coil 208 such that the connection to the power supply is at opposite ends of the coil FIG. 5A or the coil can return such that the connection to the power supply is adjacent, as shown in FIG. 5B.

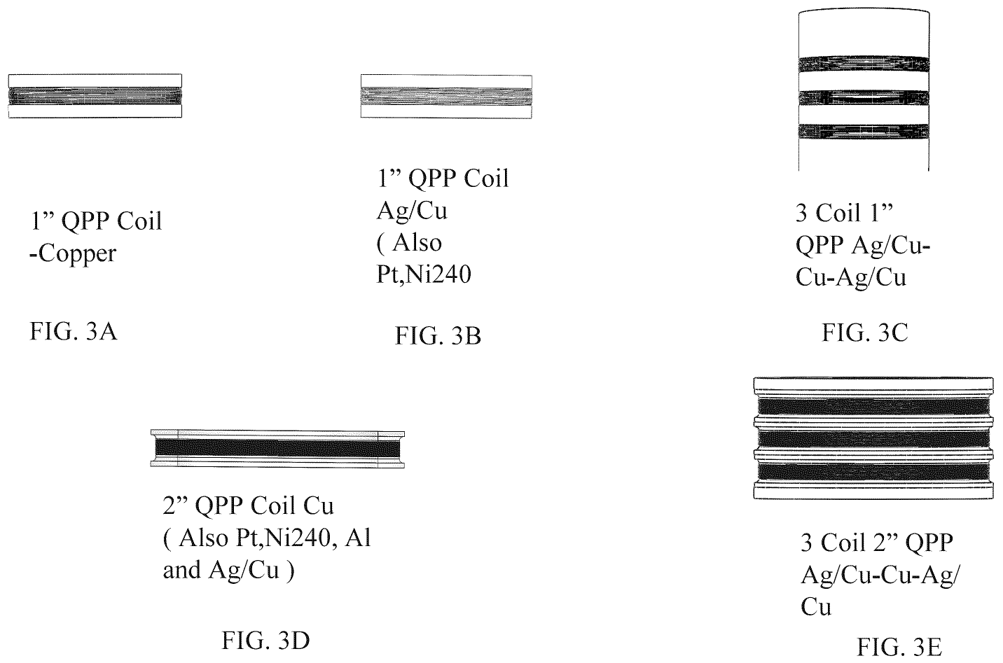

Referring to FIG. 2A, FIG. 2B, and FIG. 2C, the reactor assembly can optionally further comprise one or more coils 208, preferably surrounding the reactor body and its containment system. For example, the reactor assembly can comprise 1, 2, 3, 4, 5, 6, 7, 8, 9, or 10 or more coils, also called RA coils. As shown in FIG. 2B, one or more electromagnetic (E/M) coils can be used to provide magnetic fields. Preferably, 1, 2, 3, 4, or 5 or more E/M coils can be used, more preferably 3, 4, or 5 E/M coils. FIG. 3A-3E shows groupings of three coils, for example, which can generally be numbered 1, 2, or 3, from top to bottom. A grouping of coils, as shown in FIG. 3A-3E, can be called a boundary. Where a plurality of groupings is used, the number of coils used is independently selected. Further, the groupings can be equidistantly spaced along or irregularly spaced.

Coils can be manufactured from electrically conducting materials, such as, without limitation, copper, platinum, silver, rhodium, palladium and, wire braids or coated wires of two or more materials. Each coil in a grouping may be made of the same material or different. For example, a grouping can be made such that each coil is made of a different material. For example, a braiding of copper wire and silver wire can be used. Silver plated copper wire can be used. A first RA coil can be made of a copper winding. A second RA coil can be a copper/silver braid. A third RA coil can be a platinum wire winding. An RA coil can be configured to create a magnetic field and wherein each power supply independently provides AC and/or DC current. Any one or all RA coils can be optionally lacquered.

The coils are preferably circular in geometry. However, other geometries, such as, without limitation, rounded shapes, ellipses and ovoids can be used. The wire diameter can be between about 0.05 mm (>about 40 gauge) and about 15 mm (about 0000 gauge) or more. For example, the wire diameter can be between about 0.08 mm (about 40 gauge) and about 0.8 mm (about 20 gauge) wire. Excellent results have been obtained using 0.13 mm (36 gauge) wire. Coils can be wire windings (e.g., the wire can be wound in 1, 2, 3, 4, 5, 6, 7, 8, 9, 20, or more turns or can be a single turn. In this context, a “wire” can also be considered a band where the width of the material is greater than the depth. FIGS. 3 A-E provide illustrations or views of various coils and groupings of coils. A wire coil can be made of a single wire, a wire alloy or two or more wires. For example, two wires comprising different metals can be wound or braided together.

The inner diameter (or dimension(s) where the coil is not a circle) of each coil can be the same or different and can be between 2 and 200 cm.

Coils 208 can independently be connected to one or more power supplies, such as an AC or DC power supply or combination thereof. For example, an AC current can be supplied to alternating (1, 3, and 5, for example) or adjacent coils (1, 2 and/or 4, 5, for example) while DC current is supplied to the remaining coils. Current can be provided (independently) in a frequency, such as in a patterned frequency, e.g., triangle, square or sine pattern or combination thereof. The frequency supplied to each coil can be the same or different and between 0 to 50 MHz or higher. While the coils 208 can generate and transfer thermal energy, or heat, to the reactor feed gas they are predominantly used to create a magnetic field.

The power supply can be an AC and/or DC power supply or combination thereof. Current can be provided (independently) in a frequency, such as in a patterned frequency, e.g., triangle, square or sine pattern or combination thereof. The frequency supplied to each coil can be the same or different and between 0 to 50 MHz or higher, such as between 1 Hz to 50 Mhz.

As described above, the RA coils typically surround the reactor chamber and/or reactor head space. For example, a first RA coil can be aligned with the first (or bottom) frit. A second RA coil can be aligned with the reactor chamber or nanoporous carbon bed. A third RA coil can be aligned with the second (or top) frit. Where present, a fourth RA coil can be disposed between the first RA and the second RA coil. When present, a fifth RA coil can be disposed between the second RA coil and third RA coil. When two or more reactor chambers, or nanoporous carbon beds are present, it can be desirable to add additional RA coils, also aligned with a second or additional reactor chambers or nanoporous carbon beds. Additional RA coils can be added to align with additional frits when present.

The RA coils can typically be supported in a support or stator to maintain a fixed distance between each coil. The support, when present, can be transparent. In one embodiment, the RA coils can be configured in a cartridge that can be removed or moved.

The RA coils can, additionally or alternatively, be aligned with the reactor headspace. The reactor headspace can typically be a volume above the second, or top, frit. It is understood that where the reactor assembly is positioned horizontally (or at some other angle than vertical), the geometry of the spaces is maintained, albeit rotated. The reactor headspace can typically be an enclosed volume. For example, the reactor assembly can be inserted into a closed ended transparent (e.g., glass) tube, vial or bottle. The reactor assembly can be movably engaged with the RA coils (or boundary), thereby permitting each RA coil to align to a different element within the reactor assembly. For example, the first RA coil can be realigned with the reactor chamber.

Referring to FIG. 2A, FIG. 2B, and FIG. 2C, a reactor body 202 can also be a packed, moving, or fluidized bed or other configuration characterized by one or more chambers that receive the charge material 204 and facilitates transfer of a reactor feed gas through the charge material 204 and can transfer thermal and/or electromagnetic energy to the charge material 204. The reactor chamber is sized to contain the desired amount of charge material 204. For the experiments described herein, the chamber is designed to contain between 20 mg to 100 grams of nanoporous carbon powder. Larger reactors can be scaled up.

The reactor body 202 is generally contained within a housing, e.g., closed end tube, 207 and frits 203, which function to contain the charge material 204. It can be advantageous to use a reactor within a translucent or transparent housing, such as quartz or other materials characterized by a high melting point. The volume of the reactor bed can be fixed or adjustable. For example, the reactor bed can contain about 1 gram, or less of starting material, between about 1 g to 1 kg of starting material or more. Where the reactor assembly comprises two or more reactor chambers, the reactor chambers are preferably directly or indirectly stacked, preferably having a common central axis and can be separated by one or two frits.

The reactor body 202 can, for example and without limitation, be made of a thermally conductive material, such as graphite, copper, aluminum, nickel, molybdenum, platinum, iridium, cobalt, or niobium, or non-thermally conducting material, such as quartz, plastic (e.g., acrylic), or combinations thereof. An optional cup 206 capped with cap 205 can be advantageous. The cup and cap material can be independently selected. For example, a graphite cup can be combined with a graphite cap, which is the selection for the examples below. A copper cup can be combined with a graphite cap. A graphite cup can be combined with a copper cap. A copper cup can be combined with a copper cap and so on.

The reactor assembly can also receive the gas line through the entrance, or inlet, 201 and to provide an exhaust through an exit, or outlet, 209, optionally controlled by valves. A head space defined by a closed end tube 207 can be configured above the reactor body. The reactor body is preferably made of graphite, copper, or other inorganic rigid material. The gas line is preferably made of an inert tubing, such as glass, acrylic, polyurethane, plexiglass, silicone, stainless steel, and the like can also be used. Tubing can, optionally, be flexible or rigid, translucent or opaque. The inlet is generally below the charge material. The outlet can be below, above or both.

Frits 203 used to define the chamber containing the charge material are also shown. The frits can be made of a porous material which permits gas flow. The frits will preferably have a maximum pore size that is smaller than the particle size of the starting material. Pore sizes of between 2 and 50 microns, preferably between 4 and 15 microns can be used. The thickness of the frits can range satisfactorily between approximately 1 and 10 mm or more. The frits are preferably made of an inert material, such as silica or quartz. Porous frits from Technical Glass Products (Painesville Tp., Ohio) are satisfactory. On the examples below, fused quartz #3 porous frits (QPD10-3) with a pore size between 4 and 15 microns and a thickness of 2-3 microns and fused quartz frits with a pore size between 14 and 40 microns (QPD10-3) were used. The purity of the frits exemplified herein was very high, 99.99% wt, to ensure that the results obtained cannot be dismissed as the result of contamination. Frits of lower purity and quality can also be used. The diameter of the porous frit is preferably selected to permit a snug fit within the reactor interior, or cup. That is, the diameter of the porous frit is approximately the same as the inner diameter of the reactor or cup, if present.

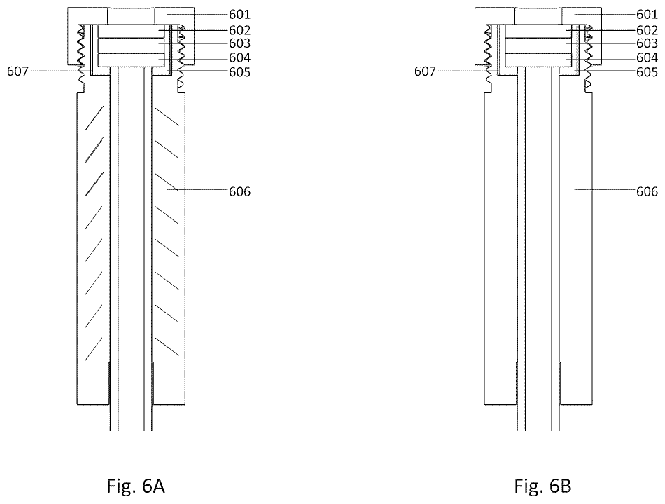

FIGS. 6A and 6B are illustrations of two examples of two composite reactor assemblies. FIG. 6A illustrates a Composite Reactor with a copper reactor body 606, carbon graphite cup 605, and a carbon graphite cap 601 and a metal foil boundary 607. FIG. 6B illustrates a Composite Reactor with a carbon graphite reactor body 606 and cap 601 and metal foil boundary 607. The embodiments depicted in FIG. 6A and FIG. 6B show a top frit 602 and a bottom frit 604, with a graphite bed 603 therebetween. Referring to FIGS. 6A and 6B, a foil 607 can optionally encase the chamber containing the charge material on the inside and/or outside of the frits 602, 604 and/or cup 605, thereby creating a metal boundary surrounding the starting material. The foil 607 can be a metal, such as copper, platinum, niobium, cobalt, gold, silver, or alloys thereof. The foil 607 can also be graphite or the like. The foil 607 can be between 0 and 0.5 cm thick, preferably 1-10 mm. The profile of the reactor can be linear, or it can be configured to contain a constriction below the lower frit, providing the general appearance of a lollipop.

The reactor assembly may be augmented with additional forms of electromagnetic radiation, such as light. FIG. 4B exemplifies light sources 426 and 427 that generate light directed through the reactor housing 415 and starting material contained therein. Preferred light sources 426 and 427 can be lasers and/or can emit light in a wavelength between 10 nm and 1 mm. The light is optionally subjected to one or more filters 428, as shown in the use of light sources (beams) in FIG. 4B. Preferably, the reactor assembly comprises 2, 3, 4, 5 or more pairs of lamps disposed circumferentially around the RA coils. Pencil lamps, such as the lamps used within the E/MEE, which is incorporated herein by reference from above, are preferred. The pairs of lamps preferably define a boundary surrounding the coil and are not touching or otherwise adjacent to the coils. Two lamps are considered paired where they are proximal to each other, such as within the same plane with the center axis of an RA coil. Paired lamps can be parallel or orthogonal to each other and the RA coil center axis. Lamps can be considered proximal to each other if the space between any two points between the lamp tip and base is within 10 cm, preferably within 5 cm. Lamps that are positioned orthogonally to the RA coil center axis are generally positioned along the line defined by the radius of one or more RA coils.

The RA lamps, e.g., the pencil lamps proximal to the reactor body, can be matched, or paired, to one or more E/MEE lamps, e.g., the pencil lamps residing within the E/MEE housing and proximal to the gas line. For example, where an E/MEE pencil lamp is a neon lamp, a pair of RA lamps can be neon pencil lamps. Additionally, where an E/MEE pencil lamp is a neon lamp, a pair of RA lamps can be neon pencil lamps. Such matched lamps can emit light characterized by substantially the same wavelength. This can be conveniently achieved by using lamps from the same manufacturer with the same specifications.

The reactor can be in a closed or open housing 415 and can be supported therein by reactor supports. The reactor feed gas is directed to the reactor inlet frit, or bottom frit, directed through the starting material contained within the housing 415 and exits the reactor at the reactor exit frit, or top frit. The reactor feed gas can then be exhausted or recycled, optionally returning to the E/MEE for further treatment.

The reactor can further comprise an x-ray source 211 (FIG. 2C) or 424 (FIG. 4B) and/or one or more lasers 212 (FIG. 2C) or 426 and 427 (FIG. 4B). Preferred x-ray sources include a mini-x. The x-ray is preferably directed through the reactor towards a gas headspace, or target holder 213 (FIG. 2C), above the charge material. The x-ray can be directly or indirectly provided from the source, such as by reflecting the x-ray from a foil disposed above or below a frit.

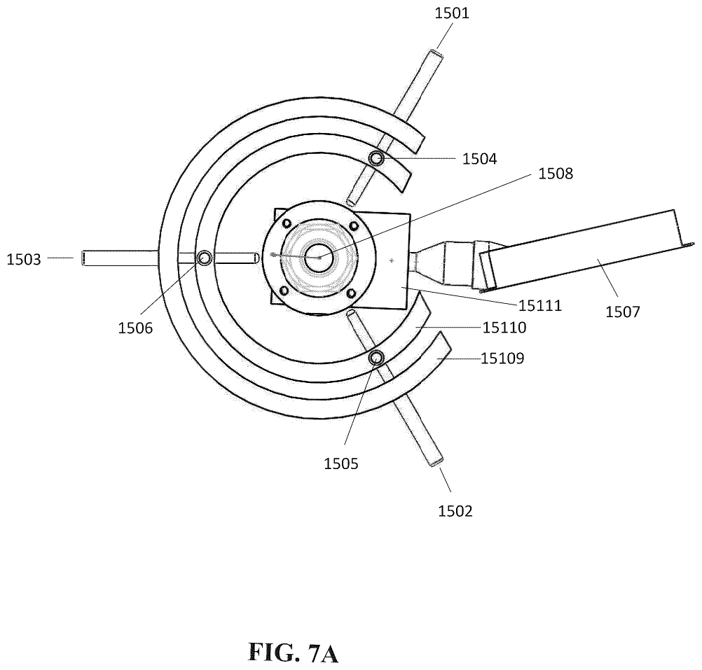

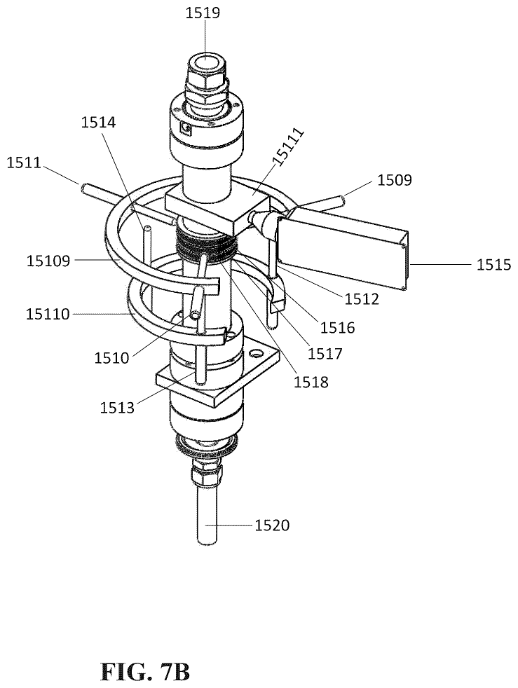

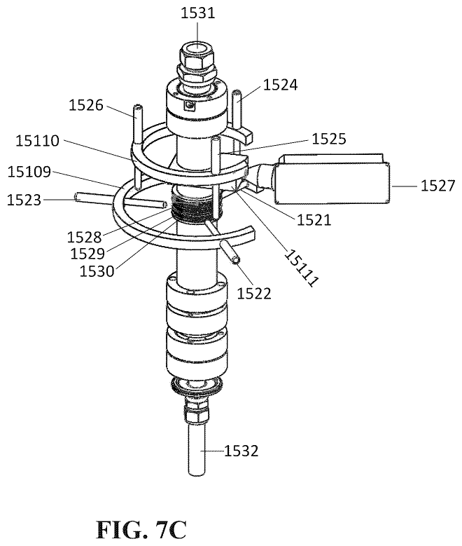

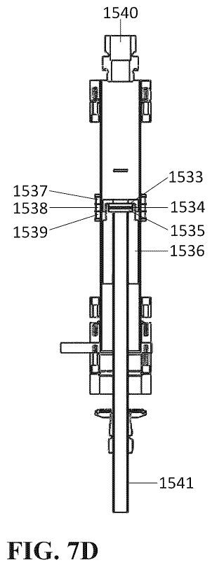

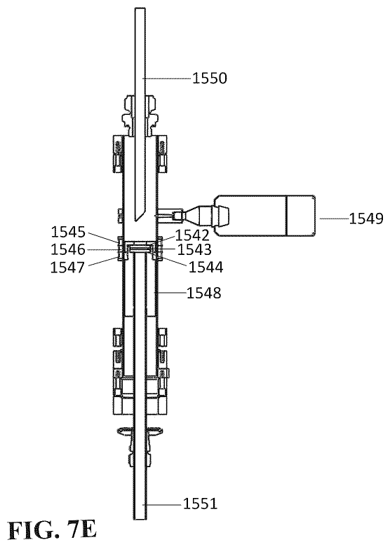

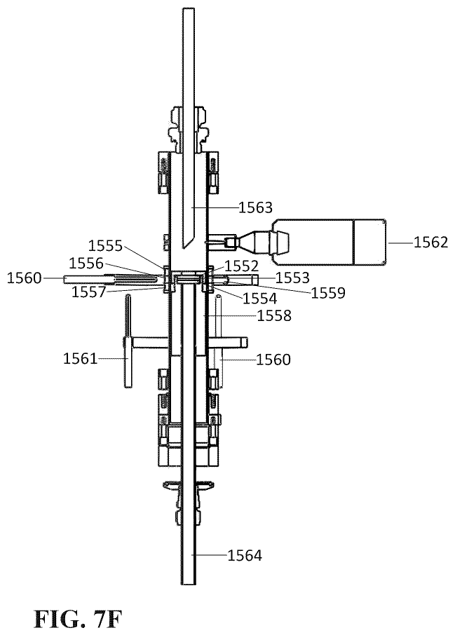

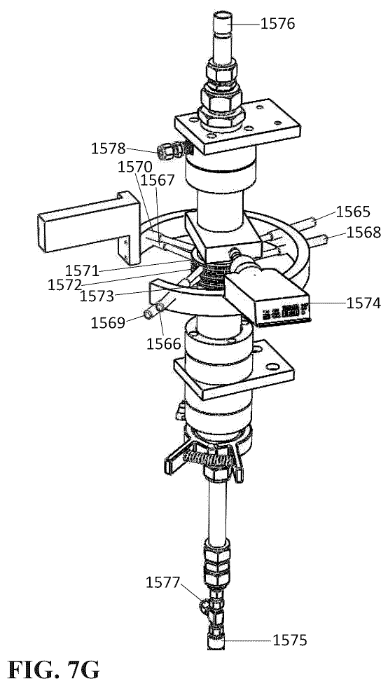

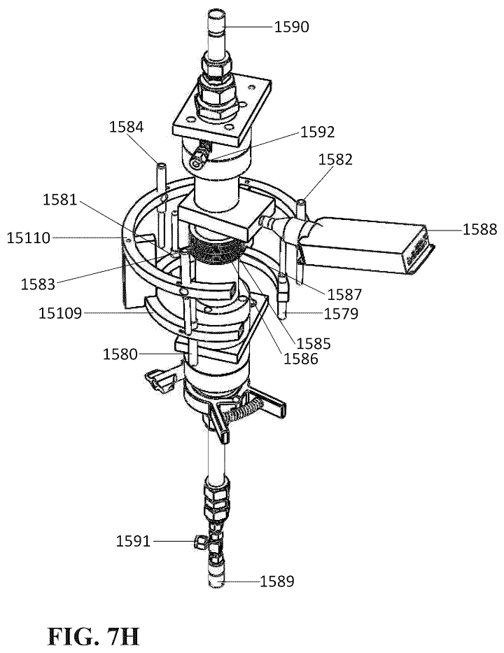

FIG. 7A illustrates a top view of a preferred reactor assembly. Pencil lamp 1501, pencil lamp 1502 and pencil lamp 1503 are shown with the tip directed towards a center axis of the reactor assembly along a radius of the reactor assembly. Pencil lamp 1504, pencil lamp 1505 and pencil lamp 1506 are shown directed parallel to a center axis of the reactor assembly and are disposed in a plane along a radius of the reactor assembly. Pencil lamp 1501, together with pencil lamp 1504, form a first RA lamp pair. Pencil lamp 1502, together with pencil lamp 1505, form a second RA lamp pair. Pencil lamp 1503, together with pencil lamp 1506, form a third RA lamp pair. As with the E/MEE pencil lamps, each RA lamp can be rotated along its x, y or z axis. Each pair can optionally reside within the same radial plane, as shown. Outer support 15109 provides support for the pencil lamps 1501, 1502 and 1503. Inner support 15110 provides support for the pencil lamps 1504, 1505 and 1506. The outer and inner supports are preferably made of non-conductive materials (such as polymers or resins) and are preferably transparent. An optional x-ray source 1507 is shown directing x-rays towards the center axis of the reaction chamber 1508. Reactor connector 15111 is also shown.

FIG. 7B is a perspective view of this reactor assembly. Pencil lamp 1509, pencil lamp 1510 and pencil lamp 1511 are shown directed with the tip towards a center axis of the reactor assembly along a radius of the reactor assembly. The tip of each lamp aligns with the center, or third, RA coil 1517 and is in the same horizontal plane. Pencil lamp 1512, pencil lamp 1513 and pencil lamp 1514 are shown directed parallel to a center axis of the reactor assembly, disposed in a plane along a radius of the reactor assembly and is characterized by a tip pointing towards top of the reactor, away from the gas inlet 1520. These lamps are illustrated above the horizontal pencil lamps. The length of each pencil lamp align with RA coils 1516, 1517 and 1518. Outer support 15109 and inner support 15110 support the pencil lamps. An optional x-ray source 1515 is shown directing x-rays towards the center axis of the reactor assembly above the third RA coil 1516. Disposed within the reactor assembly can be a reflecting plate to direct the x-ray towards the reaction chamber. Reactor connector 15111 is also shown, as well as other non-material connectors and spacers. Gas inlet 1520 and gas outlet 1519 are also shown.

FIG. 7C is a second perspective view of a reactor assembly. Pencil lamp 1521, pencil lamp 1522 and pencil lamp 1523 are shown directed with the tip towards a center axis of the reactor assembly along a radius of the reactor assembly. Pencil lamp 1524, pencil lamp 1525 and pencil lamp 1526 are shown directed parallel to a center axis of the reactor assembly, disposed in a plane along a radius of the reactor assembly and is characterized by a tip pointing towards the bottom of the reactor, towards the gas inlet 1532. These vertical lamps are shown above the horizontal lamps and, again, each pair of lamps can optionally lie in the same radial plane. The tip of each pencil lamp aligns with the third RA coil 1528. Outer support 15109 and inner support 15110 support the pencil lamps. Three RA coils 1528, 1529 and 1530 are shown. An optional x-ray source 1527 is shown directing x-rays towards the center axis of the reactor assembly. Disposed within the reactor assembly can be a reflecting plate to direct the x-ray towards the reaction chamber. Reactor connector 15111 is also shown, as well as other non-material connectors and spacers. Gas inlet 1532 and gas outlet 1531 are also shown.

FIG. 7D is a cross sectional side view of the reactor assembly, stripped of the pencil lamps and x-ray source. Gas enters at the inlet 1541 and exits at the outlet 1540. RA coils 1537, 1538 and 1539 are shown. The first, or bottom, frit 1535 and the second, or top, frit 1533 contain the reaction chamber 1534, which can be charged with nanoporous carbon powder. The reactor body 1536 is also shown. Other non-material spacers and connectors remain unlabeled.

FIG. 7E is a second cross sectional side view of a reactor assembly, stripped of the pencil lamps and x-ray source. Gas enters at the inlet 1551. RA coils 1545, 1546 and 1547 are shown. The first, or bottom, frit 1544 and the second, or top, frit 1542 contain the reaction chamber 1543, which can be charged with nanoporous carbon powder. The reactor body 1548 is also shown. X-ray source 1549 directs x-rays towards the center axis of the reactor assembly which is then deflected towards the reactor chamber with element 1550. Other non-material spacers and connectors remain unlabeled.

FIG. 7F is a second cross sectional side view of a reactor assembly with the pencil lamps and x-ray source. Gas enters at the inlet 1564. RA coils 1555, 1556 and 1557 are shown. The first, or bottom, frit 1554 and the second, or top, frit 1552 contain the reaction chamber 1553, which can be charged with nanoporous carbon powder. The reactor body 1558 is also shown. Vertical pencil lamps 1560 and 1561 are shown as are horizontal pencil lamps 1560 and 1559. X-ray source 1562 directs x-rays towards the center axis of the reactor assembly which is then deflected towards the reactor chamber with element 1563. Other non-material spacers and connectors remain unlabeled.

FIG. 7G is a perspective view of a reactor assembly with the pencil lamps and x-ray source. Gas enters at the inlet 1577 and exits at outlet 1578. A first laser 1575 and a second laser 1576 directing radiation towards the reaction chamber along the axis of the reactor assembly is shown. RA coils 1571, 1572 and 1573 are shown. In this embodiment, pencil lamps 1565, 1566, 1567, 1568, 1569, and 1570 are all shown horizontally disposed in pairs along the radius towards the reactor assembly central axis. Tips are proximal to RA coils 1571, 1572 and 1573. X-ray source 1574 directs x-rays towards the center axis of the reactor assembly. Support 15109 (FIG. 7A) supports all of the horizontal pencil lamps. Other non-material spacers and connectors remain unlabeled.

FIG. 7H is a perspective view of a reactor assembly with the pencil lamps and x-ray source. Gas enters at the inlet 1591 and exits at outlet 1592. A first laser 1589 and a second laser 1590 directing radiation towards the reaction chamber along the axis of the reactor assembly is shown. RA coils 1585, 1586 and 1587 are shown. In this embodiment pencil lamps 1579, 1580, 1581, 1582, 1583, and 1584 are all shown vertically disposed in pairs in radial planes aligned with the RA coils. Tips are proximal to RA coils 1585, 1586 and 1587. X-ray source 1588 directs x-rays towards the center axis of the reactor assembly. Supports 15109 and 15110 support the pencil lamps. Other non-material spacers and connectors remain unlabeled.

FIG. 7I is a perspective view of a reactor assembly illustrating 5 RA coils, horizontal pencil lamps and an x-ray source. Gas enters at the inlet 15107 and exits at outlet 15108. A first laser 15105 and a second laser 15106 directing radiation towards the reaction chamber along the axis of the reactor assembly is shown. RA coils 1599, 15100, 15101, 15102 and 15103, defining a cylindrical boundary, are shown. In this embodiment pencil lamps 1593, 1594, 1595, 1596, 1597, and 1598 are all shown horizontally disposed in pairs in radial planes aligned with the RA coils. Tips are proximal to RA coils 1599 and 15103. X-ray source 15104 directs x-rays towards the center axis of the reactor assembly. Support 15109 supports the pencil lamps. Other non-material spacers and connectors remain unlabeled.

i. Ni-1 Reactor:

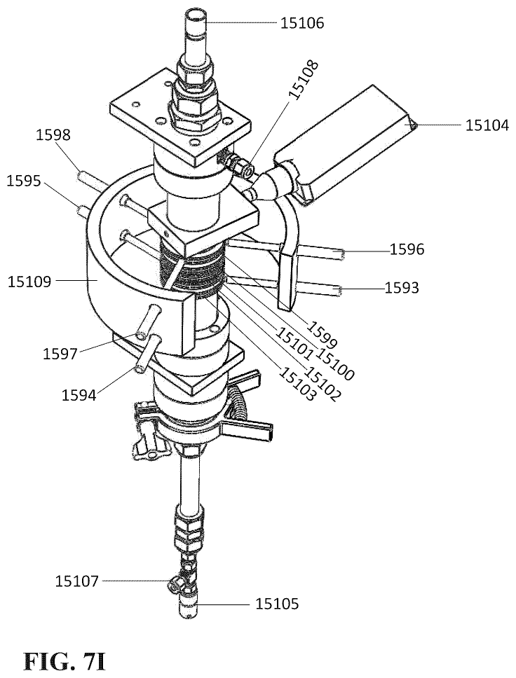

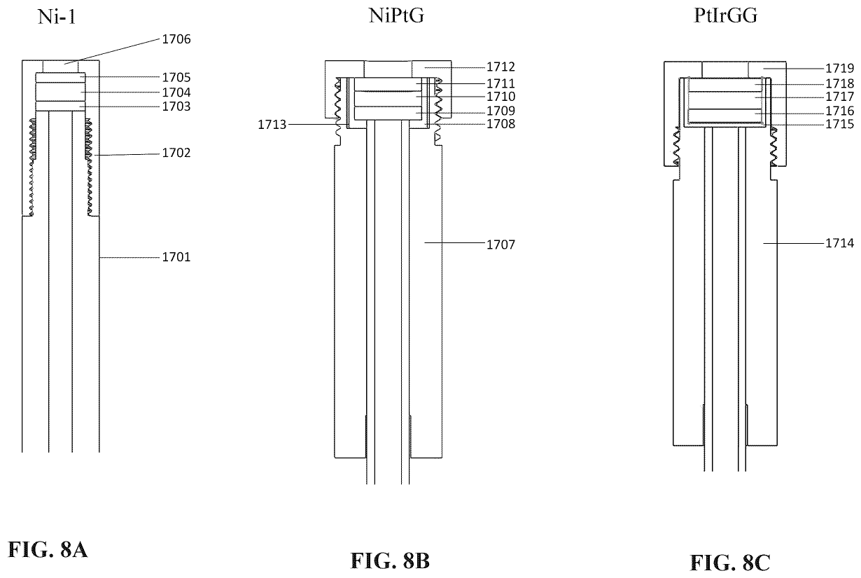

Referring to FIG. 8A, the reactor body (1702) is based on a high purity nickel (Ni) rod. The Ni rod, with an outside diameter of 15.873 mm (OD) is bored through then machined with a female thread on one end. The inside diameter allows for the installation of upper and lower frit and carbon bed. The carbon reaction medium is housed inside the reactor body (1702). To load the reactor, the reactor body (1702) is positioned with the gas discharge opening (1706) facing down on a flat surface. A quartz frit (1705) is placed inside the reactor body (1702) to form the upper containment. 100 mg of carbon is then loaded into the reactor body (1702). After loading of the graphite bed inside the reactor body (1702), a second quartz frit (1703) is installed. A reactor pole (1701), machined out of a high purity graphite rod with matched male threads for the reactor body (1702), is then screwed onto the reactor body (1702).

The reactor pole (1701) is designed to allow and provide for graphite bed compression (1704) equivalent to that provided by the cup design (1710 in FIG. 8B and 1717 in FIG. 8C).
ii. NiPtG Reactor:

Referring to FIG. 8B, in the NiPtG Reactor embodiment, the reactor body (1707) is based on a high purity nickel (Ni) rod. The Ni rod, with an outside diameter of 15.873 mm (OD) is bored through then machined on one end to have an inside diameter of 11.68 mm (ID). The inside diameter allows for the installation of a graphite cup (1708) and an optional 0.025 mm platinum (Pt) foil (1713). The graphite cup provides for reactor wall and foil isolation from the carbon bed. The carbon reaction medium is housed inside a 990.9999_{wt} % pure graphite cup (1708). To load the reactor, a quartz frit (1709) is placed inside the graphite cup (1708) to form the bottom containment. 100 mg of carbon (1710) is then loaded into the cup (1708). After loading of the graphite bed inside the cup, a second quartz frit (1711) is installed; this system is defined as the cup assembly. Prior to installing the cup assembly, the foil (1713) is used to line the inside surface of the reactor wall. The cup assembly is then placed within the nickel reactor body (1707) and foil (1713). After the cup assembly is installed, a 99.9999_{wt} % pure graphite cap (1712) is screwed onto the reactor body. The cap secures the cup from movement after assembly.

iii. PtIrGG Reactor:

Referring to FIG. 8C, the reactor body (1714) is based on a high purity graphite rod. The graphite rod, with an outside diameter of 15.873 mm (OD) is bored through then machined on one end to have an inside diameter of 11.68 mm (ID). The inside diameter allows for the installation of a graphite cup (1715) for reactor wall isolation from the carbon bed. The carbon reaction medium is housed inside a 990.9999_{wt} % pure graphite cup (1715). To load the reactor, a quartz frit (1716) is placed inside the graphite cup to form the bottom containment. 100 mg of carbon (1717) is then packed into the cup. After loading of the graphite bed inside the cup, a second quartz frit (1718) is installed; this system is defined as the cup assembly. The cup assembly is then placed within the graphite reactor body (1714). After the cup assembly is installed, a cap (1719) composed of platinum and 10% wt iridium is screwed onto the reactor body. The cap secures the cup from movement after assembly.

The residence time of the starting material within the reactor is effective to instantiate, or filter, or isolate, or extract, or nucleate, product into the starting material and can be between 0 and 15 minutes or more.

Preferred reactors used in the methods of the invention are shown in the table below.

TABLE 1

| Reactor | Cup | Cap | Reactor | Pole | | Chamber | | |
|---|---|---|---|---|---|---|---|---|
| ID | Material | Material | Material | Material | Boundary | Capacity | | Coil Type |
| CgF | N/A | N/A | Cu, Ni | graphite | N/A | 100 | mg | Induction |
| | | | or Mo or | | | | | |
| | | | graphite | | | | | |
| CuG | Graphite | graphite | Cu | quartz | N/A | 100 | mg | Induction |
| | | | | | | | | or |
| | | | | | | | | Frequency |
| PtIrGG | Graphite | Pt/Ir | graphite | quartz | N/A | 100 | mg | Induction |
| GPtG | Graphite | graphite | graphite | quartz | Pt | 100 | mg | Induction |
| | | | | | | | | or |
| | | | | | | | | Frequency |
| GPtGPtG | Graphite | graphite | graphite | quartz | 2X Pt | 100 | mg | Induction |
| GG-EL | Graphite | graphite | graphite | quartz | N/A | 100 mg-3 g | | Induction |
| | | | | | | | | or |
| | | | | | | | | Frequency |
| Foil (Pt) | Graphite | graphite | graphite | quartz | Pt | 100 | mg | Induction |
| | | | | | | | | or |
| | | | | | | | | Frequency |
| GZ Foil | Graphite | graphite | graphite | quartz | Nb, Co or | 100 | mg | Induction |
| | | | | | Pt | | | or |
| | | | | | | | | Frequency |
| nZG Foil | Graphite | Any Z | graphite | quartz | Ir | 100 | mg | Induction |
| | | | | | | | | or |
| | | | | | | | | Frequency |
| NiG | Graphite | graphite | Ni | quartz | N/A | 100 | mg | Induction |
| | | | | | | | | or |
| | | | | | | | | Frequency |
| NiPtG | Graphite | graphite | Ni | quartz | Pt | 100 | mg | Induction |
| ZG | N/A | Pd/Ru or | graphite | quartz | N/A | 100 | mg | Induction |
| | | any Z | | | | | | |
| Ref-X | Graphite | graphite | graphite | quartz | N/A | 1-20 | g | Frequency. |

The invention further relates to methods of instantiating materials in nanoporous carbon powders. It has been surprisingly found that light elements, such as hydrogen, oxygen, helium, and the like are instantiated, or filtered, or isolated, or extracted, or nucleated. Instantiating is defined herein to include the nucleation and assembly of atoms within carbon structures, particularly, ultramicropores, and it includes without limitation processes such as filtering, or isolating, or extracting, or nucleating such atoms. Without being bound by theory, it is believed instantiation is related to, inter alia, degrees of freedom of the electromagnetic field as expressed by quantum field theory. By exposing a gas to harmonic resonances, or harmonics, of electromagnetic radiation within one or more ultramicropores, vacuum energy density is accessed and allows for the nucleation and assembly of atoms. Electromagnetic energy that is within the frequencies of light, x-rays, and magnetic fields subjected to frequency generators can enhance the formation and maintenance of such harmonics. Modifying the boundaries of the system, by selecting the reactor materials and adding a foil layer can also enhance the harmonics.

In particular, the invention includes processes of producing, or instantiating, nanoporous carbon compositions comprising the steps of:
adding a nanoporous carbon powder into a reactor assembly as described herein;
adding a feed gas to the reactor assembly;
powering the one or more RA coils to a first electromagnetic energy level;
heating the nanoporous carbon powder;
harmonic patterning the nanoporous carbon powder between a first electromagnetic energy level and a second electromagnetic energy level for a time sufficient to instantiate, or filter, or isolate, or extract, or nucleate, a chemical reactant in a nanopore and, optionally, collecting the chemical reactant.

The invention includes a process for producing a chemical reactant comprising the steps of:
(a) adding a feed gas to an electromagnetic embedding apparatus:
(b) exposing the feed gas to at least one E/MEE light source;
(c) directing the feed gas from step (b) to a reactor assembly comprising:
   A gas inlet and one or more gas outlets;
   A reactor chamber containing a nanoporous carbon disposed within a cup and, optionally, covered with a cap;
   A first porous frit defining a floor of the reactor chamber disposed within the cup,
   A second porous frit defining the ceiling of the reactor chamber; wherein each porous frit has a porosity that is sufficient to allow a gas to permeate into the reactor chamber;
   A reactor head space disposed above the reactor chamber;
   At least one RA coil surrounding the reactor chamber and/or reactor head space operably connected to a power supply, wherein the computer processing unit is configured to control the power supply to the RA coil;
(d) subjecting the nanoporous carbon powder to harmonic patterning to instantiate, or filter, or isolate, or extract, or nucleate, the chemical reactant integrated within a product composition;
(e) collecting the product composition comprising the chemical reactant; and
(f) isolating the chemical reactant from the product composition.

The term “harmonic patterning” is defined herein as oscillating between two or more energy levels (or states) a plurality of times. The energy states can be characterized as a first, or high, energy level and a second, or lower, energy level. The rates of initiating the first energy level, obtaining the second energy level and re-establishing the first energy level can be the same or different. Each rate can be defined in terms of time, such as over 1, 2, 3, 4, 5, 6, 7, 8, 9, 10 or more seconds. Each energy level can be held for a period of time, such as 1, 2, 3, 4, 5, 6, 7, 8, 9, 10 or more seconds. Harmonic patterning is continued until instantiation is achieved.

Where two more electromagnetic radiation sources are present (e.g., coils, x-ray source, lasers, and/or lamps), each can be subjected to harmonic patterning and the patterning can occur independently, simultaneously or sequentially.

The process further comprises independently powering any additional electromagnetic radiation source, as described above in the E/MEE apparatus or reactor assembly. For example, the process further comprises the step(s) of powering RA frequency generator(s) connected to one or more RA coils, one or more lamps or lasers, x-ray sources, induction coils, E/MEE coils, and the like substantially as described above.

c. Use Cases for Chemical Reactants

Methods and apparatus for producing chemical reactants in accordance with these inventions can be appreciated in more detail by reference to the following description and Figures.

i. General Use Cases

In general terms, a reactor assembly (RA) as disclosed herein can instantiate, or filter, or isolate, or extract, or nucleate, a chemical product that can be collected and commercialized separately, for example for use in conventional chemical reactions, a RA as disclosed herein can also interface with a system within which a chemical reaction can take place, which chemical reaction utilizes the chemical reactant(s) produced by the RA. Such a system for utilizing chemical reactants to support chemical reactions can be termed a “reaction system,” (RS) and it can comprise an apparatus or enclosure within which a chemical reaction takes place. The term “reaction system” is not limited to closed vessels for reactions, since it is understood that certain chemical reactions such as flame combustion do not require a closed system, but can occur in “the open.” As described previously, a RA produces a chemical reactant that can be supplied to a RS; one or more RAs can produce one or more chemical reactants, to be used by one or more RSs.

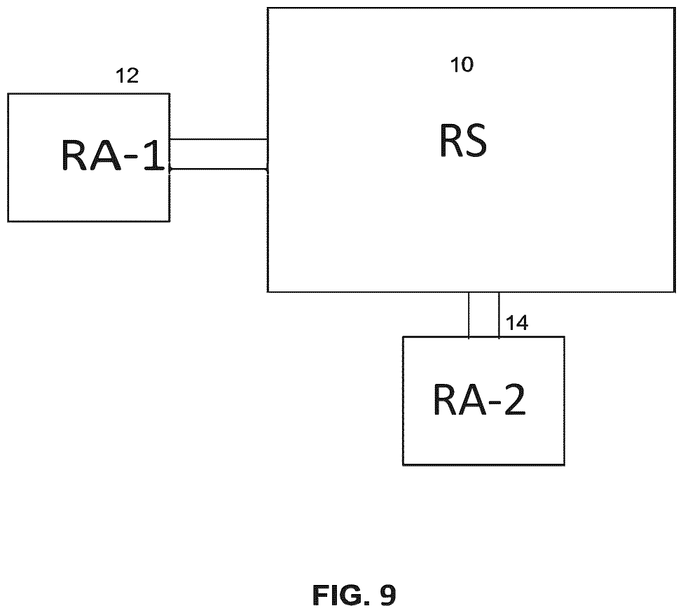

In the exemplary embodiment, shown schematically in FIG. 9, a plurality of RAs, (RA-1, 12 and RA-2, 14) can produce the same or different substances, to be supplied to RS 10. As an example, one RA can produce a chemical reactant useful as a fuel (e.g., H₂), while the other RA can produce a chemical reactant useful as an oxidizing agent (e.g., O₂). These chemical reactants can be conveyed into the RS 10, where the designated reaction takes place, advantageously producing energy or other reaction products that can be beneficially employed. RAs such as RA-1 (12) and RA-2 (14) are capable of instantiating a desired chemical substance(s) or mixture of chemical substances, including but not limited to simple mono-elemental atoms and molecules (e.g., alkali metals such as Na, alkaline earth metals such as Ca, H₂, O₂, halogen molecules such as Cl₂, etc.), simple multi-elemental molecules comprising at least two elements (e.g., CO, NH₃ or H₂O₂, etc.), or complex multi-elemental molecules comprising at least two elements in various distinguished configurations (e.g., hydrocarbons, carbohydrates, alcohols, etc.). As depicted in FIG. 9, the RAs 12 and 14 can be coupled to any RS apparatus 10 that can immediately, or almost immediately, or at other timing, consume the chemical substance(s) (such as fuel(s)) through combustion or other chemical reaction.

In an exemplary embodiment, as described below in more detail, the RS 10 acting as a “fuel-sink” can be, without limitation any fuel-consuming apparatus, such as an engine, that converts fuel to mechanical energy alone or in combination with any other fuel-consuming apparatus such as, without limitation, (i) a thermal apparatus that converts fuel to heat; or a fuel-cell that converts fuel to electricity; (ii) any other apparatus that consumes a chemical substance; (iii) any fuel-storage facility such as a tank or other container that stores the fuel; or (iv) any reactant-transformation process that uses a chemical reactant as a feedstock or precursor in the production of other chemicals or materials, or any combination of the foregoing.

As depicted in FIG. 9, the RAs 12 and 14 can be coupled to any RS apparatus 10 that can immediately, or almost immediately, or at other timing, consume the chemical substance(s) such as fuel(s) through combustion or other chemical reaction. These various dispositions of chemical substances such as fuels/reductants or oxidants can be generalized by the concept of “fuel/reductant sink” and “oxidizer sink”. Accordingly, the output(s) of such RA(s) 12, 14 in some embodiments is/are directed through a “conduit” to a “fuel sink” or an “oxidizer sink” which receives the fuel/reductant or oxidizer and processes it.

Systems incorporating one or more Ras in communication with one or more RSs can include one or more fuel consumers, one or more fuel retainers and one or more fuel transformers. For example, RAs 12 and/or 14 can be coupled to a storage facility apparatus whereby the chemical substance(s) (e.g., a fuel) can be retained for use elsewhere or later; or can be moved through a conduit for other processing such as being used as a feedstock or precursor to the production of other chemicals.

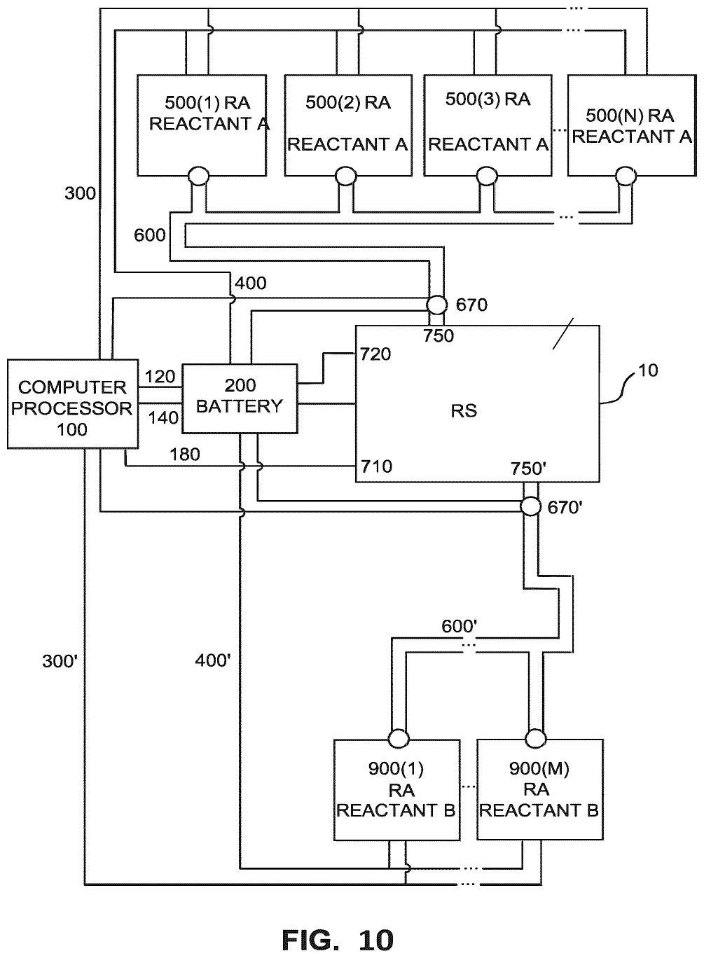

In embodiments, a plurality of Ras can be harnessed to form an integrated system delivering appropriate quantities of chemical reactants to a RS in order to achieve a desired reaction. Such a system is illustrated in FIG. 10. FIG. 10 depicts a series of Ras 500(1-n) that supplies a chemical substance such as a fuel to a RS 10 via a conduit 600. In the example shown, “N” RA(s) 500(1), 500(2), . . . , 500(N) (where N is any positive integer) can be configured to assemble the fuel or fuel mixture in sufficient quantities appropriate for the fuel sink and deliver the fuel to the fuel sink, i.e., RS 10.

In the depicted example, “M” Ras(s) 900 (where M is zero or any positive integer) can be configured to assemble a second chemical substance, such as a chemical reactant (e.g., an oxidant) appropriate for the fuel sink and deliver the chemical substance to the fuel sink, i.e., RS 10. It is understood that the RA bank or set 900(1)-900(M) is optional, to be used in systems where a second chemical substance is to be provided to the RS in addition to the chemical substance produced by the RA bank or set 500(1)-500(n). Any number of additional Ras or banks or sets of Ras can be provided to supply any number of and quantity of chemical substances individually, alternately, simultaneously or in any desired mixtures or ratios, to RS 10.

The chemical substances produced by Ras 500, 900 are supplied to RS 10 via one or more conduits 600, 600′. Thus, as material moves between points it is said to move through a “conduit”. Examples of such materials include without limitation: hydrogen, ammonia (NH₃), hydrocarbons, alcohols (as fuels); oxygen, ozone, hydrogen peroxide (H₂O₂), (as oxidants); helium, xenon, argon, krypton, (as elements to moderate or buffer the reaction); nitrogen, other gases, fuels, oxidizing agents, boron, calcium, aluminum, and any other elements or compounds used within the system. Depending on an implementation's design and engineering constraints, a “conduit” may vary from being a trivial, almost abstract, connection to a complicated path in which a number of operations are performed, sometimes conditionally, on the subject material. Such operations may include, for example and without limitation, being: pumped, collected, combined, e.g., combined with the output of other conduits or sources, pressurized, compressed, liquefied, solidified, stored, packaged, transported, hauled, unpackaged, repackaged, gasified, uncompressed, depressurized, filtered, mixed, agitated, centrifuged, shaken, oscillated, stirred, vibrated, gated, shunted, injected, diverted, merged, blown, aerated, propelled, spun, blended, dissolved, extracted, sensed, tested, humidified, dehumidified, monitored, measured, regulated, accumulated, cooled, heated, or otherwise processed. Such operations may involve the use of components including for example and without limitation: pumps, sensors, gates, shunts, injectors, valves, baffles, pipes, splitters, plumbing, relays, filters, controls, accumulators, tanks, containers, reservoirs, fans, blowers, propellers, impellors, aerators, agitators, oscillators, vibrators, shakers, stirrers, centrifuges, pressurizers, humidifiers, dehumidifiers, compressors, refrigerators, blenders, mixers, vats, dissolvers, extractors, coolers, heaters, gasifiers, liquefiers, and sensors and controls for flow, humidity, concentration, density, purity, particle size, particle diameter, particle surface area, particle weight, viscosity, temperature, volume, and pressure, as well as other sensors and controls and processing equipment. Each operation may be performed zero or more times, sometimes simultaneously, and the order in which they are performed (and whether they are appropriate or necessary) depends on a particular implementation's design, tradeoffs, and constraints. Conduits may also be used to route power and signal cables. A conduit 600, 600′ may thus without limitation comprise a single pipe or other structure capable of conducting fluids (preferably gases), a conveyor for conducting powders or solids, a blower system for moving powders or gas. A manifold that couples the outputs of multiple Ras 500 together as a bank or set of Ras, a mixer that mixes the outputs of multiple Ras together, or any other suitable structure for conveying outputs of Ras 500, 900 to RS 10. As shown in FIG. 10, a conduit can act as a fuel intake manifold for delivering the instantiated chemical reactants to the RS 10. The conduit(s) 600, 600′ may also convey fuel supplied by another fuel source(s), for example, a storage tank or other production process such as e.g., electrolysis. Such additional source(s) could be used in some embodiments and/or under some operating conditions in addition to RA(s) 500, 900 to provide sufficient fuel quantities and/or flow rates and/or combinations to meet demands of the RS 10. For example, RA(s) 500, 900 may operate for an extended period of time to develop substances for storage in storage tanks, and RS 10 may later consume the substances stored in the storage tanks. Delivery of chemical reactants from RAs to the one or more RSs can be coordinated by control systems that monitor aspects of the overall system, and that regulate the flow of materials through the different components of the overall system. In the embodiment depicted in FIG. 10, aspects of each RA 500, 900 are monitored and regulated by processor 100 through bus 300/300′, which may comprise a digital data bus in one embodiment. The various monitored aspects may include, without limitation, power, temperature, humidity, configuration, pressure, flow, concentration, viscosity, density, purity, particle dimension, and any other relevant state or parameter; together with the operation of fans, blowers, oscillators, pumps, valves, reservoirs, accumulators, pressurizers, compressors and/or other devices used to support the processes shown.

The processor 100 may also send signals over bus 300/300′ to control aspects of the state and operation of each RA 500, 900 such as flow control, output rate, and any other relevant state, parameter or characteristic. As shown in FIG. 10, computer processor 100 provides an electronic controller that senses, monitors, coordinates, regulates, and controls the various aspects of chemical substance production and usage. Processor 100 is connected as needed (120, 140, 180, 300, 300′, etc.) to other various components (200, 500, 900, 670, 670′, 10) to receive sensor input signals and send control signals. Computer processor 100 may be operatively coupled to a non-transitory storage device(s) (not shown) that stores executable instructions. The computer processor 100 may include a CPU(s) and/or a GPU(s) that reads instructions from the storage device and executes the instructions to perform functions and operations the instructions specify. In some embodiments, the computer processor 100 can comprise or consist of hardware such as a programmable or non-programmable gate array, an ASIC or any other suitable implementation comprising hardware and/or software. In some embodiments, processor 100 can be implemented as multiple processors which may, although not necessarily, be mutually connected or communicating and including an absence or any plurality of connection or communication means. Computer processor 100 receives operating power 120 from the battery 200, from which it can also receive sensory signals 140 and to which it can send control signals. Implementations can have connections beyond those specifically illustrated here, from computer processor 100 to other components. For example, computer processor 100 can be operatively coupled to numerous input sensors; numerous output devices such as actuators, displays and/or audio transducers; and digital communication devices such as buses, networks, a wireless or wired data transceivers, etc.

In some embodiments, battery 200 provides ancillary power to various components in addition to processor 100. Battery 200 is shown external to the reactor, although in many embodiments it can be internal to the reactor, such as if the RS is implemented as or includes a fuel cell, an alternator/generator, or possesses other electrical power generation capabilities, if present, to receive and maintain charge. In some embodiments, battery 200 can be supplemented or replaced by other power sources such as solar panels, fuel cells, generators, alternators, or any external power sources, etc. In embodiments, the system depicted in FIG. 10 can have connections from battery 200 and processor 100 to other components not shown in the Figure. In embodiments, a battery 200 can be included as an initial power source. A battery 200 can also be useful in remote locations; in situations where battery acquisition, maintenance, or replacement may be difficult; or in emergency and special situations. In embodiments, the system and/or its battery 200 can provide for being jump-started with manually operated, or other kinetic current sources, or with solar panels.

In an embodiment, an operator (and/or the computer processor 100) activates the system by setting an ignition switch (not shown) to “on”. Referring to FIG. 10, this action by the operator or computer processor 100 gates power from battery 200 to the other components as appropriate, which can include RAs 500, 900 (if present), the processor 100, and optionally the RS, for example in systems where the RS requires preparation in anticipation of fuel flow. Once started, processor 100 senses, monitors, coordinates, regulates, and controls, as necessary, the activity and interaction of all components. The RAs 500, 900 (if present) can be started under control of processor 100, with the appropriate environment being established for producing the desired chemical reactants, including as examples and without limitation: power, temperature, humidity, pressure, charge, and electromagnetic fields. If sensors and controls in the RAs 500, 900 (if present) are required, such signals can be transmitted through bus 300/300′ to and from the processor 100. Once ready, the RAs 500, 900 (if present) are operationally activated under control of processor 100, which thereafter senses, monitors, coordinates, regulates, and controls RAs 500, 900 to ensure proper operation.

In an embodiment, the RAs 500 are activated to instantiate, or filter, or isolate, or extract, or nucleate, a chemical reactant useful as a fuel material, which can be atoms or molecules, such as hydrogen (H₂). The chemical reactant produced by the RAs 500 is/are collected by the conduit 600, optionally purified or separated, which can further process it in various ways (denoted by the chemical processor 670) as appropriate before it is delivered to the RS 10 through an intake port 750. The chemical processor 670 can include various aspects of conduit(s) 600 that may exist and be attached to processor 100 and battery 200. Similarly, RAs 900 in one embodiment can instantiate, or filter, or isolate, or extract, or nucleate, a chemical reactant useful as an oxidizing agent which can be atoms or molecules, such as oxygen (O₂). The chemical reactant emitted by the RAs 900 (1-M) (if present) is/are collected by the conduit 600′ which can process it in various ways (denoted by the chemical processor 670′) as appropriate before it is delivered to the RS 10 through its reactant intake 750′.

After an operation reacting the different chemical reactants takes place in the RS 10 with satisfactory completion, the computer 100 can conduct a proper close-down for the RAs 500, 900, conduits 600, 600′, processors 670, 670′, RS 10, battery 200, any other integrated equipment, and for itself 100. The satisfactory completion of the intended chemical reaction in the RS 10 can be determined in various ways depending on the particular specific embodiment. In certain embodiments, the completion can be signaled by the operator setting an ignition switch (not shown) to “off,” or can be signaled via some computer interaction or artificial intelligence decision, or can be signaled by any sensor, detector, monitor, or probe interior to, or exterior to RS which may be available to the processor, or can be signaled by parameters pertaining to the RS itself, such as the passage of time or the generation of heat or other energy, or can be signaled by the status of a storage unit or other non-reactive fuel sink, such as a storage tank reaching a full state.

The Figures that follow depict use cases that exemplify the principles for the RAs and RSs as disclosed herein.

ii. Use Cases Involving Fuels Generally

In embodiments, the invention particularly relates to the identification and collection of chemical reactants useful as fuels produced by the disclosed methods. In embodiments, the methods and apparatus disclosed above can produce chemical reactants such as fuel substances and/or reductants including, but not limited to, the many and varied substances containing hydrogen, carbon, nitrogen, oxygen, calcium, sodium, potassium, phosphorus, sulfur, or other materials, such as other oxidizable materials, such as, by way of example but not limited to: hydrogen (H₂), carbon (C), carbon monoxide (CO); ammonia (NH₃); unsaturated aliphatic hydrocarbons, such as alkynes and alkenes (including olefins); saturated hydrocarbons (e.g., alkanes, paraffins); cyclic and polycyclic hydrocarbons including aromatic compounds; heterocyclic compounds; and a vast collection of other organic compounds, of which a small sample includes: alcohols, such as alkanols (such as monohydric (CₙH₂ₙ₊₁OH), diols or polyols, unsaturated aliphatic, alicyclic, and other alcohols having various hydroxyl attachments); nitroalkanes such as nitromethane (CH₃NO₂); carbohydrates; and the like. In embodiments, these fuel substances can include substituted or unsubstituted alkanes or paraffins of various sizes and structures, for example methane (CH₄), ethane (C₂H₆, CH₃CH₃), propane (C₃H₈), butane (C₄H₁₀); pentane (C₅H₁₂), hexane (C₆H₁₄), heptane (C₇H₁₆), octane (C₈H₁₈), C₉-C₁₆ alkanes, or heavier molecules can also be used as fuel or for other purposes, such as lubricating oil, wax, or asphalt. In many cases, the methods and apparatuses disclosed herein can directly instantiate, or filter, or isolate, or extract, or nucleate, the chemical substance, the production of which might otherwise require transformation by a chemical reaction or a different source.

While the use of these methods and apparatuses for producing conventional chemical reactants useful as fuels (including but not limited to those disclosed herein) is especially advantageous, these methods and apparatuses also are capable of producing materials not usually considered to be fuels, but which can be economically harnessed in appropriate situations for the energy of their exothermic fuel-like reactions with other chemical substances, such as oxygen and other oxidizing agents described herein. Such atypical fuels produced by these methods and apparatuses include those elements such as calcium, sodium, lithium, and the like, that are so reactive in the natural environment that they are not encountered in their unbound, elemental state. Examples of such atypical fuels include, without limitation, alkali metals: Li (which can react, e.g., with O₂, H₂O, CO₂, N₂), Na, K, and the like; alkaline earth metals (Be, Mg, Ca, and the like); and those other elements and compounds that can be involved in exothermic reactions, such as Al, Fe, CaO, and the like, including for example but without limitation, those that can be made to undergo exothermic reactions, such as Al, Fe, CaO. While the reactions involving conventional fuels tend to take place via a redox mechanism using an oxidizing agent such as oxygen, the chemical substances available as fuels are not limited to those that undergo redox reactions. Atypical fuels can produce energy through non-redox mechanisms, for example, a reaction between metal oxide such as CaO, and H₂O, and similar reactions.

Chemical reactants produced by the methods and apparatuses disclosed herein can also include oxidants (i.e., oxidizing agents), which can be used to react with reductants or fuels produced by the methods and apparatuses disclosed herein, or which can be isolated to be used for other purposes. The oxidants that can be instantiated, or filtered, or isolated, or extracted, or nucleated, by these methods and apparatuses include without limitation, atomic oxygen and oxygen species, hydrogen peroxide, water (which can exothermically oxidize alkali metals, alkaline earth metals, and the like, and can exothermically react with alkali metal oxides or alkaline earth metal oxides such as CaO), halogen molecules such as F₂, Cl₂, Br₂, and the like, and other reactive metals (e.g., metal oxides) or non-metals.

In embodiments, the invention particularly relates to the identification and collection of chemical reactants useful as fuels produced by the methods disclosed herein. In embodiments, reactors as described herein can produce and extract chemical feedstock substances for more complex chemical reactions, making them available for further processing that includes, without limitation, the use of chemical reactions such as substitution and addition of other reagents such as chlorine, or other chemicals; and/or physical processes such as mixing, blending, melting, softening, refining, hardening, vaporizing, cooling, distilling, liquefying, solidifying, freezing, crushing, powdering, exuding, extruding, rolling, smelting, alloying and the like, to produce more advanced products such as solvents (e.g., nail polish, paints, naphtha (mothballs)); lubricating oils; waxes and paraffins; asphalt; polymers (e.g., polyester, polyethylene, polypropylene, polystyrene, acrylates); aromatic compounds (e.g., benzene, toluene, xylene, and the like); pharmaceutical small molecules; vitamins; fertilizers; pesticides; and the like.

Fuels or reactants produced by the methods and apparatuses disclosed herein can be stored in various containers or other retaining mechanisms for use elsewhere. Such containers or retaining mechanisms (collectively, “retainers”) allow the chemical reactants thus produced to be stored for use elsewhere or at a later time. Retainers can include, without limitation, bags, tanks or bottles (for fluids (preferably gases), caves (for gases), bags, envelopes or boxes (for solids), conduits, or any other vessel or other structure that at least for a discernible period of time (whether short or long), either while in transit or statically, stores a quantity of the chemical reactant.

### 3. Engines Using Instantiated Fuels

a. Engines Generally

A number of use cases can be envisioned that employ one or more RAs, as described above, for the production of fuels to be used in one or more RSs in systems that function as engines. As used herein, the term “engine” refers to any artificially constructed machine or system that converts one or more forms of energy into mechanical energy, where mechanical energy is understood to be the energy that is possessed by an object due to its position and/or its momentum. As known in the art, mechanical energy can be either kinetic energy (energy of motion) or potential energy (stored energy of position), and total mechanical energy is the sum of kinetic and potential energy. Objects have mechanical energy if they are themselves in motion, or if they occupy a position relative to a zero potential energy position. Mechanical energy can be understood as the ability to do work: mechanical energy enables an object to apply force to another object to cause displacement, with the work produced being expressed by the following standard equation EQ. 1:

Work=Force×displacement×cos Θ, EQ 1:
where Θ is the angle between the force vector and the displacement vector.

Available energy sources for engines include potential energy, heat energy, electric potential energy, nuclear energy, and chemical energy. Certain of these processes generate heat as an intermediate form, so that engines employing them can be described as heat engines even if the immediate source of the heat is some other reaction, such as a chemical or a nuclear reaction. Mechanical heat engines convert heat into work by well-understood thermodynamic and thermomechanical processes.

As an example, a conventional internal combustion engine uses chemical reactions (for example combustion) to produce heat, which in turn causes the rapid expansion of combustion products in the combustion chamber; this rapid volumetric expansion can drive a piston, which then turns a crankshaft. As another example, the gases produced by the combustion can be released from the combustion chamber in a directed stream, for example through a nozzle, that can interact with the blades of a turbine or comparable force converter, whereby the force of the rapidly exiting gases impacts the force converter and produces useful work, for example by turning the turbine blades.

A number of conventional engines are powered by chemical reactions, either to produce heat (as in the internal or external combustion engine) or to produce rapidly expanding gases that can act on external engine components to produce useful work. Those engines that employ air as part of a fuel reaction are termed airbreathing engines. Those engines that are powered by chemical reactions but without use of the Earth's atmosphere or other gaseous oxygen sources need to have self-contained fuel sources to produce the chemical reactions that provide the motive force to the vehicle that contains them.

Chemically fueled heat engines produce heat and chemical reaction products (exhaust products), the composition of which is determined by the reactants that enter into the initial chemical reaction. It is desirable to control the components of these exhaust gases if they are to be released into the atmosphere, to minimize an engine's emissions. Hydrocarbons are a common source of fuel for heat engines, but they produce CO₂ (a potent greenhouse gas) as an exhaust product. Hydrogen fuel is favored because of its less damaging exhaust product profile: when combined with oxygen, it forms only water. However, hydrogen can also react with the nitrogen in the atmosphere as well as the oxygen, yielding harmful NOₓ products that are expelled into the atmosphere. An ideal target of “zero emissions” has been proposed, whereby the engine produces no waste products that impact the environment. A heat engine that combusts pure hydrogen as fuel and pure oxygen as oxidizer (without input from the atmosphere) will produce only water as its exhaust, thus attaining zero emissions. Such engines can be constructed using RAs as described herein.

In embodiments, engine systems using the methods and apparatuses of the invention can include, without limitation:
Internal combustion engines using instantiated H₂ as fuel for combustion with O₂ or Oₙ, where the O₂ or Oₙ, can be instantiated, or filtered, or isolated, or extracted, or nucleated, by one or more RAs, and/or where the O₂ can be provided externally, for example by a separate feedline or from the atmosphere;
Internal combustion engines using instantiated diesel (C₉H₂₀ to C₁₁H₂₄) as fuel for combustion with O₂, where the O₂ can be instantiated, or filtered, or isolated, or extracted, or nucleated, by one or more RAs, and/or where the O₂ can be provided externally, for example by a separate feedline or from the atmosphere;
Internal combustion engines using instantiated C₈H₁₈ as fuel and instantiated or non-instantiated O₂, such as ambient atmospheric O₂ as oxidant;
External combustion engine, e.g., “steam engine,” using an exothermic reaction produced by the combustion of an instantiated fuel and an oxidant such as ambient atmospheric O₂.
Turbine engine using instantiated NH₃ or instantiated H₂ as fuel and ambient atmospheric O₂ as oxidant or instantiated O₂, or H₂O₂ (hydrogen peroxide) as oxidant;

As used herein, the term “internal combustion engine” refers to an engine in which the combustion of a fuel occurs in a combustion chamber creates gaseous products of combustion, the expansion of which within the combustion chamber exerts a force on a mechanical component wholly or partially within the combustion chamber (an “internal engine component”) to produce work. As used herein, the term “combustion” refers to a high-temperature exothermic redox chemical reaction between a fuel (the reductant) and an oxidant, to yield oxidized products and heat. The oxidant is often atmospheric oxygen, although other sources of oxygen can be used as well.

Combustion in the combustion chamber typically yields reaction products that are high-temperature and high-pressure gases; the production of these gases applies a force to a component of the engine such as a piston, a rotor, a nozzle, or a set of turbine blades, wherein the component is moved over a distance, thereby transforming the chemical and heat energy into kinetic energy. This kinetic energy will then carry out the desired work for which the engine is being utilized, for example, to propel a vehicle or to carry out a stationary function, such as pumping, grinding, compressing, mixing, moving industrial articles, generating electricity, or otherwise powering a machine to carry out a desired useful action. Common to all internal combustion engines is the redox reaction of a fuel and an oxidant, with the resulting chemical products, such as hot gaseous products of combustion; work is typically extracted from the expansion of the products of combustion, and ultimately the products of combustion are released through the exhaust system.

Internal combustion engines can be configured as intermittent-combustion or continuous-combustion engines. The intermittent-combustion engine operates by the periodic ignition of oxidizer or air and fuel, with mechanical energy being produced in a cyclic manner. The continuous-combustion engine is characterized by a steady flow of fuel and oxidizer into the engine, with a stable combustion process maintained within the combustion chamber. Intermittent combustion engines operate by an organized series of combustions; continuous combustion engines involve ongoing combustion with the production of continuous power.

Intermittent combustion engines include reciprocating engines and rotary engines. Reciprocating engines typically include an engine block or analogous structure within which a plurality of combustion chambers are arranged. A movable piston is positioned within each combustion chamber so that the heat energy that is created by the combustion results in a translation of the piston from a position in which the fluid volume of the cylinder is maximally compressed to a position in which the fluid volume of the cylinder is maximally expanded The piston is coupled to a force coupler such as a crankshaft so that the motion of the piston from the first position to the second position is translated into motion of the force coupler, wherein the motion of the force coupler produces the desired work. For example, a crankshaft is a force coupler that can translate the reciprocating motion of a series of pistons into a rotational motion. Other varieties of force couplers that translate the motion of the pistons into useful work will be familiar to artisans of ordinary skill. Rotary engines do not use reciprocating piston strokes to drive a moving crankshaft. Instead of a linear reciprocating motion of a set of pistons to rotate a crankshaft, a rotary engine can be pistonless, harnessing the compression and expansion of gases within the combustion chamber via an eccentrically designed rotor; an example of this is the Wankel engine. A rotary engine can also involve pistons that fire in an alternating order and rotate around a central, fixed crankshaft.

A gas turbine engine is a specialized example of a continuous combustion engine. The intake gas can be initially compressed and then mixed with a fuel, which is fed into the combustion chamber where the combustion process is underway. The larger volume of heated reaction products in the combustion chamber is fed into a turbine that captures the mechanical energy. As gases pass at high velocity through the turbine, they generate sufficient work to power the intake compressor, and furthermore produce additional work that can be delivered to a shaft to power an electric generator or other material, or to be released at high velocity to provide thrust. As used herein, the term “gas turbine” refers to a rotary engine that extracts energy from a continuous flow of combustion gases. The gas turbine engine is a type of internal combustion engine that generates its power by expelling the gaseous products of combustion from the combustion chamber to act upon an external mechanical engine component such as turbine blades. Such an external engine component is operatively associated with the combustion chamber so that the rapidly expanding gaseous products of combustion can act upon it as those products are expelled from the combustion chamber; however, the operative aspect of the external engine component is situated outside the combustion chamber, so that the force from the expelled products of combustion is transferred to the engine component to produce useful work. For example, the gases striking the turbine blades cause them to turn, which can rotate a central shaft to produce useful work.

As used herein, the term “external combustion engine” refers to a heat engine in which the combustion of a fuel that occurs in combustion chamber heats or otherwise affects a working fluid that is contained in separate compartment not in fluid communication with the combustion chamber. In embodiments, an external combustion engine can produce heat that is transmitted from the combustion chamber to the working fluid through an engine wall or a heat exchanger, so that the working fluid interacts with other, downstream components of the engine system to produce motion and usable work; for example, the working fluid can expand when heated and thereby move mechanical components of the engine system. As used herein, the term “working fluid” refers to a fluid (i.e., a gas or a liquid or a combination of the two) that can transfer mechanical energy. In an external combustion engine, the combustion itself is used as a heat source to transmit heat energy to the working fluid, and the working fluid in turn transforms this energy into a desired set of output forces and movements. Working fluid used in an external combustion engine can be discarded after its energy has been transmitted to other machine components (such as the steam used in a locomotive that is discharged through the smokestack) or it can be reused. The former arrangement is termed an open cycle external combustion engine, and the latter arrangement is termed a closed cycle external combustion engine. Working fluids used in an external combustion engine can be single-phase (either gaseous or liquid), or can be dual phase, wherein the phase transition occurs as the heat is taken up by the working fluid, for example with a change from a liquid to a gaseous state at a much larger volume. Working fluids for external combustion engines include without limitation fluids such as water (at various temperatures and pressures), air, sulfur dioxide, fluorocarbons including without limitation chlorofluorocarbons and hydrochlorofluorocarbons, organic materials including without limitation propane, butane, isobutane, pentane, inert gases such as helium, other gases or gas/liquid two-phase fluids such as ammonia, and liquid metals.

Most common fuels for both internal and external combustion engines are made up of hydrocarbons, for example diesel fuel, gasoline, petroleum gas, propane, and the like. Conventional engines have been modified to use hydrogen gas as a fuel, which avoids the production of CO₂ that accompanies the combustion of hydrocarbon fuels. Experimental engines have used other fuels such as powdered magnesium.

The methods and apparatus disclosed herein can be used for any sort of engine, such as a reciprocating piston engine, a gas turbine engine, a steam or other turbine engine, or any other engine that consumes fuel to output mechanical power. In general terms, a reactor assembly (RA) as disclosed herein can interface with a system within which a chemical reaction can take place such as an engine, in which the chemical reaction yielding the mechanical energy produced by the engine utilizes the chemical reactant(s) produced by the RA. As used herein, a the term “reaction system” (RS) refers to a system for utilizing chemical reactants to support chemical reactions. As described previously, a RA produces a chemical reactant that can be supplied to a RS; one or more RAs can produce one or more chemical reactants, to be used by one or more RSs. As applied to engines, a reaction system comprises the apparatus or enclosure within which a chemical reaction takes place, for example a combustion chamber in the engine. As previously described, a reaction system for combustion can include both closed and open vessels, since combustion does not require a closed system, but can also occur in “the open,” as can be seen in external combustion engines in which the heat produced by the combustion in one open or closed compartment of the engine (the RS) produces and transmits heat energy to the working fluid in another compartment of the engine, thereby producing the mechanical energy.

In exemplary embodiments, the fuel instantiated, or filtered, or isolated, or extracted, or nucleated, by one or more RAs as described herein is suitably reactive (combustible) to power the varieties of engines disclosed herein. In embodiments, hydrogen is preferred as a fuel, although any material produced by a RA or an assembly of RAs can be used, as appropriate. Further descriptions of exemplary engine systems are provided below to illustrate the principles of the invention. Regardless of the type of engine system, however, the ultimate usage of such an engine is not restricted; without limitation, an engine embodying the principles of the invention can be deployed to drive a vehicle, generator, alternator, and other equipment, machinery, or apparatus.

b. Internal and External Combustion Engines

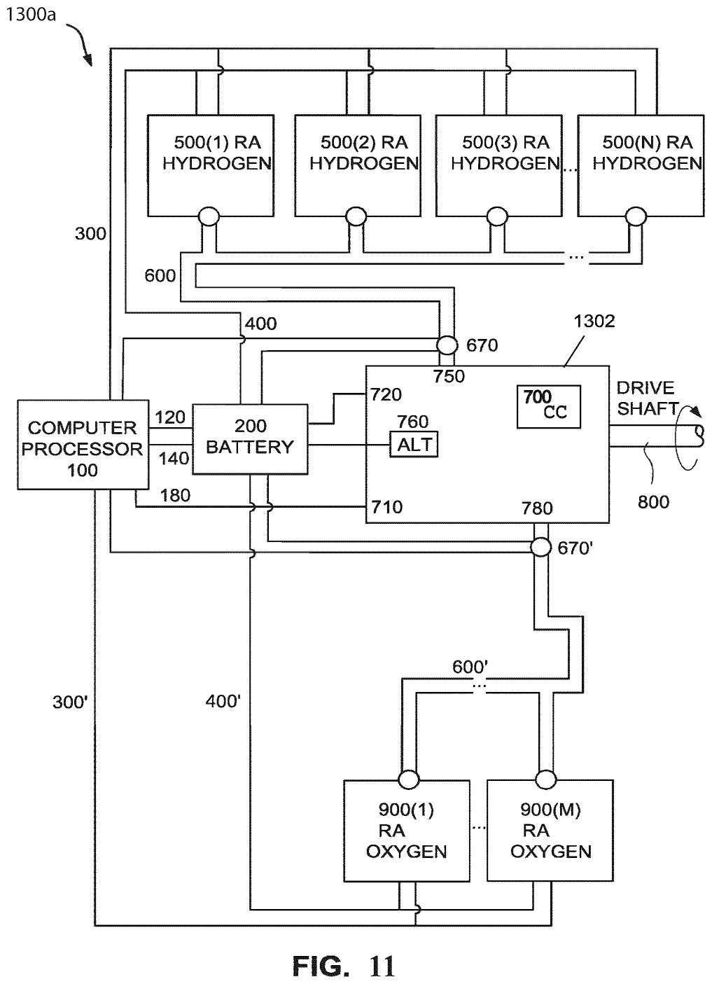

In an exemplary embodiment, an internal combustion engine incorporating the principles of the invention can be constructed as shown schematically in FIG. 11. FIG. 11 depicts a hydrogen-powered engine system 1300a that includes, at a high level, a computer processor 100, a battery or other electrical power source 200, an engine core or reaction system (RS) 1302, and a drive shaft 800 for delivering the mechanical energy produced by the reaction system for further useful work. In the depicted embodiment, the RS includes one or more combustion chambers 700 within which chemical reactants combine to produce the mechanical energy delivered to the drive shaft 800. As previously described, these chemical reactants comprise a fuel reactant and an oxidant that complete the fuel-oxidation reaction (which is typically combustion).

In the depicted embodiment, the fuel reactant and the oxidant are produced in accordance with the principles of the invention by two different banks or sets of RAs shown schematically in FIG. 11, the 500 series and the 900 series of RAs. In this Figure, RAs 500 (1 through N, where N is any positive integer) instantiate, or filter, or isolate, or extract, or nucleate, an engine fuel, for example hydrogen, and RAs 900 (1 through M, where M is any positive integer) can instantiate, or filter, or isolate, or extract, or nucleate, an oxidant like oxygen; in other embodiments, the RAs 900 (1-M) can be replaced by or supplemented by oxidant that is derived from the ambient atmosphere, or a separate feedline, or both. In more detail, one or more RAs 900 (1-M) can be used to produce a supply of oxidizing agent to react with the fuel, which can be oxygen, or any other chemical or substance that will react appropriately with the fuel provided by the RAs 500 (1-N). Oxidizing agents can include, for example, but without limitation; oxygen; or a halogen molecule such as chlorine (Cl₂), fluorine (F₂), and/or bromine (Br₂). In some embodiments, especially for those in which fluids (preferably gases) are easier to manage, hydrogen peroxide can be used as an oxidant. In some embodiments, the designated oxidizing agent can be produced, collected and managed by a system of RAs, conduits and processors that are analogous to those used for producing, collecting, and managing the fuel input, but generally separated therefrom in order to prevent premature reaction between fuel and oxidizing agent until the fuel and oxidizing agent are combined in the reaction/combustion chamber. Delivery of the oxidizing agent can take place at the same time as the delivery of the fuel, or before or after, so long as the fuel and the oxidizing agent are present at the same time in adequate quantities to permit the desired exothermic reaction to take place, i.e., synchronous delivery. During operation the combustion chamber may receive additional fuel, oxidant, and possible moderating material on a continuous or sporadic basis, as applicable to the design and constraints of the embodiment. The oxidizing agent can be injected into a combustion chamber through a valve, port, injector, nozzle, turbocharger, or other means. In some implementations, one or more RA(s) 900 can be used to produce oxidizing agent, which is used to combust a fuel provided conventionally such as from a storage tank or other process or source.

The RS 1302 can include a number of other components or subsystems useful for its function as an engine, such as the following (certain of which are not shown in FIG. 11): a reaction or combustion chamber, region or space; conventional intake components 750, 780 such as an intake manifold and intake valves or ports, a throttle, fuel injectors, etc.; a compressor that compresses incoming gas to high pressure for introduction into the combustion chamber; conventional exhaust components such as exhaust valves or ports, an exhaust manifold and an exhaust system; a turbine that extracts energy from high-pressure, high-velocity gas flowing from the combustion chamber; a nozzle that receives hot exhaust (“working fluid”) from the combustion chamber and accelerates the flow of the hot exhaust to do work or to produce thrust (as described in more detail below); conventional lubrication components such as an oil pump, an oil filter, an oil crankcase or sump, oil galleys, etc.; conventional cooling components such as a radiator or other heat sink, a coolant pump to circulate coolant, a cooling jacket, etc.; conventional ignition components such as high voltage coils and spark plugs, glow plugs, ignition charges, or any other fuel igniter, and associated wiring; a conventional electrical charging system such as an alternator 760 or generator or other electricity producer; power delivery/drive train components such as a crankshaft or rotor 800, a torque converter or clutch, a transmission, etc.

In more detail, with reference to FIG. 11, the engine core 1302 can be constructed as a hydrogen-powered engine including certain features. In the depicted embodiment, the engine 1302 can include an alternator 760 and drive or crank shaft 800, such as are typical of internal combustion engines. In the depicted embodiment, the instantiated fuel (hydrogen) enters the RS (engine) through fuel intake 750, and oxygen enters through oxygen intake 780. If the source of oxygen is ambient air, an intake 780 is fed by a conventional air intake system including a throttle, an air filter, etc. For alternate embodiments, oxygen intake 780 can be supplied by oxygen flowing through conduit(s) 600′, where such oxygen has been produced by at least one auxiliary RA 900 that has been configured to produce oxygen. Processor 100 controls the amount of hydrogen and oxygen produced by the RAs and/or supplied to the engine 1302 to control the speed and power output of the engine system 1300a.

In more detail, with reference to FIG. 11, a fuel such as hydrogen produced by the RAs 500 (1-N) is directed via fuel processor 670 and fuel intake component 750 to the engine's reaction/combustion chamber where it reacts with an oxidizing agent. Depending on the nature of the fuel and other engineering constraints, the fuel can go through additional steps including for example and without limitation, those of being: pumped, collected, combined, e.g., combined with the output of other conduits or sources, pressurized, compressed, liquefied, solidified, stored, packaged, transported, hauled, unpackaged, repackaged, gasified, uncompressed, depressurized, filtered, mixed, agitated, centrifuged, shaken, oscillated, stirred, vibrated, gated, shunted, injected, diverted, merged, blown, aerated, propelled, spun, blended, dissolved, extracted, sensed, tested, humidified, dehumidified, monitored, measured, regulated, accumulated, cooled, heated, or otherwise processed. Such operations may involve the use of components including for example and without limitation: pumps, sensors, gates, shunts, injectors, valves, baffles, pipes, splitters, plumbing, relays, filters, controls, accumulators, tanks, containers, reservoirs, fans, blowers, propellers, impellors, aerators, agitators, oscillators, vibrators, shakers, stirrers, centrifuges, pressurizers, humidifiers, dehumidifiers, compressors, refrigerators, blenders, mixers, vats, dissolvers, extractors, coolers, heaters, gasifiers, liquefiers, and sensors and controls for flow, humidity, concentration, density, purity, particle size, particle diameter, particle surface area, particle weight, viscosity, temperature, volume, and pressure, as well as other sensors and controls and processing equipment. Each operation may be performed zero or more times, sometimes simultaneously, and the order in which they are performed (and whether they are appropriate or necessary) depends on a particular implementation's design, tradeoffs, and constraints.

The expansion of gases resulting from the reaction of the fuel and the oxidizing agent within the RS 1302 (engine) provides the force which drives the engine. This can be implemented in a variety of ways depending on the type of engine and its design. In an embodiment, the RA 1302 comprises a conventional 4-stroke internal combustion engine having a reciprocating piston for each of several combustion chambers, the 4-stroke engine cycle including an intake stroke (intake valve open, exhaust valve closed), a compression stroke (intake and exhaust valves closed), a power stroke (intake and exhaust valves closed) and an exhaust stroke (exhaust valve open, intake valve closed). Valve or port timing can be controlled by rotating shafts such as a camshaft(s). In one embodiment, the engine could comprise a two-stroke engine that uses ports and provides a combined intake/exhaust stroke and a combined compression/power stroke. Another embodiment can use any conventional hydrogen internal combustion engine design such as a Wankel or other rotary design. The methods and apparatus disclosed herein can be used for any sort of engine, such as a reciprocating piston engine, gas turbine engine, a steam or other turbine engine, or any other engine that consumes fuel to output mechanical power.

As the fuel is assembled and emitted by the one or more RA(s) 500, it is conducted to the at least one reaction (combustion) chamber 700 of the engine. In some cases, such as when the fuel is hydrogen, it can be desirable to moderate the combustion temperature by running a fuel-rich or oxidant-rich mixture, or by supplying another gas into the combustion process. Examples include nitrogen (although that can lead to undesirable combustion by-products), or an inert gas (like helium, neon, argon, krypton, or xenon (although xenon has anesthetic properties which are probably often undesirable in some contexts)). Such other gas can be produced by at least one of the depicted RAs and mixed with the fuel (or oxidizer) before delivery, or it can be produced through a separate bank or set of RAs and delivered separately through its own conduit (not shown). As mentioned previously, the fuel thus produced is directed to the engine's reaction/combustion chamber where it reacts with an oxidizing agent produced by a set or bank of RAs or provided otherwise. The expansion of gases resulting from the reaction provides the force which drives the engine. This can be implemented in a variety of ways depending on the type of engine and its design.

For example, in a common piston engine having one or more combustion cylinders, the fuel is ignited to combust inside one or more cylinders to drive reciprocating pistons. In a rotary (e.g., Wankel) engine, the pressure of the fuel ignition/explosion drives a rotor to rotate. In a turbine engine, the rapid expansion of the exhaust gases exiting the reaction/combustion chamber drives turbine blades, which spins the turbine and a connected drive shaft. In a turbine engine, the force of the expanding reaction/combustion gases themselves (e.g., expelled through a nozzle in one direction) which provides an oppositely directed thrust that interacts with the blades of the turbine to move them and thus create useful work, e.g., the turning of a rotor or central shaft.

Ultimately, if the engine system 1300a comprises an engine 1302 configured as an internal combustion engine (as in the depicted embodiment), motive power is rendered through drive shaft 800. In other embodiments of internal combustion engines such as turbine engines, the expanding exhaust delivers motive power by driving a turbine attached to a central shaft.

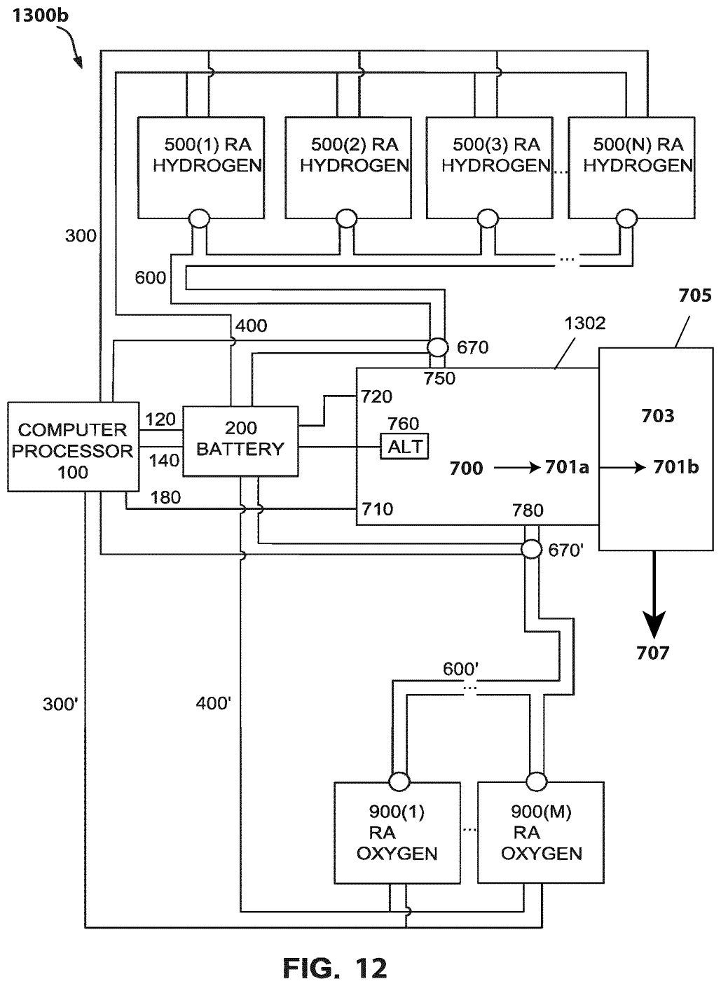

In yet other embodiments, the engine systems described herein can be configured as external combustion engines, in which the redox reaction within the engine system's combustion chamber produces energy that can be used to affect a working fluid disposed within an adjacent compartment not in fluid communication with the combustion chamber. A schematic representation of such an embodiment is depicted in FIG. 12. As shown in FIG. 12, an engine system 1300b comprises a reaction system 1302 with a combustion chamber 700 disposed within. The combustion chamber 700 produces energy 701a, for example in the form of heat, which passes into an adjacent compartment 705 that contains a working fluid 703. The energy from the combustion chamber 701a is translated into energy 701b contained within the working fluid 703, which can take the form of heat energy. The energy 701b entrained within the working fluid 703 is translated into a useful work 707 output from the overall engine system 1300b.

As described previously, the reactants for the redox reaction (i.e., the fuel and the oxidant) that takes place in the RS 1302 of FIG. 12 can be formed by the apparatus and methods of the invention: the fuel can be provided by a bank or set of RAs 500 (1-N) (similar to the 500-series depicted in FIG. 11 for production of a fuel for example hydrogen), and the oxidant for the redox reaction that takes place in the RS 1302 of FIG. 12 can be provided by a bank or set of RAs 900 (1-M) (similar to the 900-series depicted in FIG. 11, for example oxygen). In the depicted embodiment, the redox reaction (e.g., combustion) within the combustion chamber 700 can produce heat that is transmitted to the working fluid 703 in the adjacent compartment 705 to energize or expand it, allowing the working fluid to interact with other mechanical components (not shown) of the engine system to produce useful work 707; for example, the working fluid can expand when heated and thereby move mechanical components of the engine system. As described above, the working fluid 703 acted upon by the energy from the redox reaction 701a can be recycled (closed cycle system) or discarded (open cycle system). Working fluids can be selected or designed for the specific needs of the external combustion system. Such working fluids include without limitation fluids such as water (at various temperatures and pressures), air, sulfur dioxide, fluorocarbons including without limitation chlorofluorocarbons and hydrochlorofluorocarbons, organic materials including without limitation propane, butane, isobutane, pentane, inert gases such as helium, other gases or gas/liquid two-phase fluids such as ammonia, and liquid metals. Such working fluids can be provided separately for use in the external combustion engine, or can be instantiated, or filtered, or isolated, or extracted, or nucleated, in whole or in part by the RA systems of the invention.

c. Turbine Engines

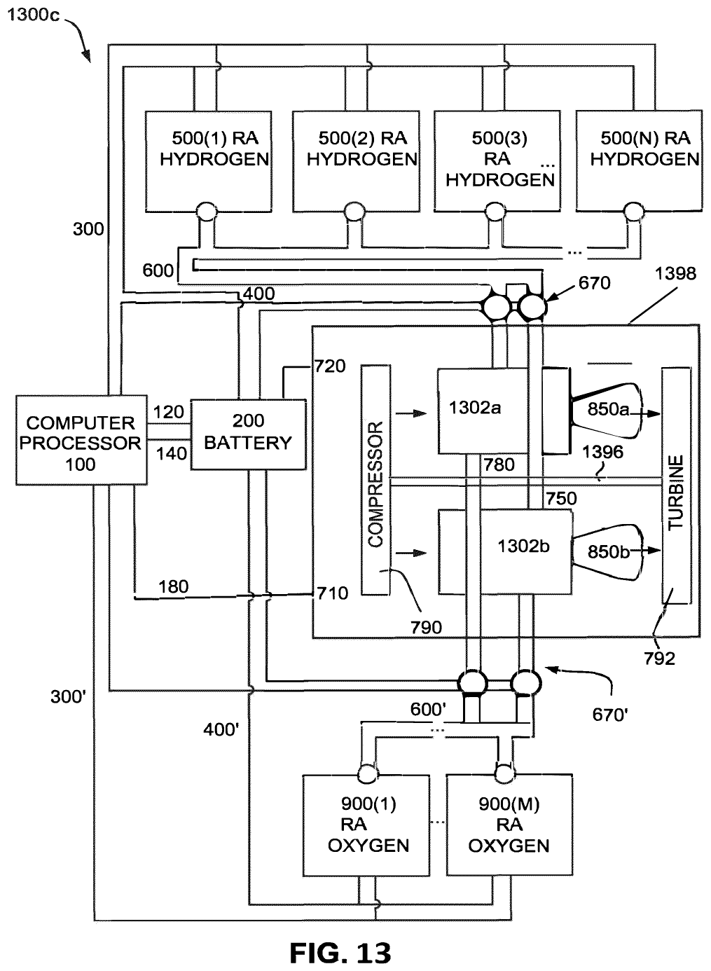

In addition to those internal and external combustion engines depicted above, where the mechanical energy produced within the combustion chamber interacts with other machine components that in turn produce the useful work, the principles of the invention are also demonstrated in those internal combustion engines in which the motive energy is provided by the rapid expansion of the combustion reaction's exhaust gases as they leave the reaction/combustion chamber. In a turbine engine, the force of the expanding exhaust gases leaving the chamber through an outlet or nozzle or the like is harnessed by a turbine to propel a vehicle or to otherwise perform useful work The embodiment depicted in FIG. 13 illustrates the principles of the invention when used in such a gas turbine engine. As shown in FIG. 13, an engine system 1300c comprises gas turbine engine 1398 that comprises a compressor 790, two combustion chambers 1302a and 1302b, and a turbine 792. In a gas turbine engine, the rapid expansion of the exhaust gases 850a and 850b exiting the reaction/combustion chambers 1302a and 1302b drives turbine 792 blades, which spins the turbine and a connected drive shaft 1396. In one embodiment, gas turbine engine 1398 operates according to the Brayton cycle.

In contrast to a reciprocating engine that depends on the up-and-down motion of a series of pistons, which then must be converted into rotary motion by a crankshaft or similar apparatus, a gas turbine typically delivers power directly to a rotary shaft or to another mechanism for capturing the power. A typical gas turbine engine is an “open cycle” engine with axial flow, in which oxygen-containing air is taken from the ambient atmosphere, compressed in a compressor (e.g., axial flow although it could also be centrifugal), and then delivered into the combustion chamber, where it mixes with fuel. Fuel is burned in the combustion chamber at an essentially constant pressure, with the combustion gases exiting the turbine to provide the motive force to the turbine or other engine-bearing apparatus (such as an aircraft). Additional compressed air that has bypassed the combustion chamber is mixed with the exhaust gases to manage their temperature as the gases encounter the turbine mechanism. If the turbine is used to power a rotary shaft, the exhaust gases are allowed to expand to atmospheric pressure within the turbine, thus turning the turbine blades to power the shaft's rotation. Most of the turbine output is used to operate the compressor that provides the compressed air on the inflow side. The rest of the turbine output can power the shaft's rotation, in turn supplying work for a generator, pump, or other device.

As shown in FIG. 13, the combustion chamber(s) 1302a, 1302b combust(s) fuel produced by set or bank of RA(s) 500 (1-N); in some embodiments, combustion is supported by oxygen or other oxidizing agent produced by the set or bank of RAs 900 (1-M). The heat of combustion forcefully expands the combustion gases as well as any other gases that are flowing through or around the combustion chamber(s) 1302a, 1302b. As these gases 850a and 850b exit the exit nozzle(s) of the combustion chamber(s), they pass through the turbine 792 where some of their expansive force is imparted to the turbine blades, which causes the turbine 792 to rotate (spin). A shaft 1396 coupled to the turbine 792 transmits rotation of turbine 792 to intake compressor 790. The intake compressor 790 compresses gas such as air for intake by the combustion chamber(s) 1302a, 1302b. Such compression of the intake air increases efficiency of the combustion chambers 1302a, 1302b, as well as the density and mass of gases participating in expansion. In one embodiment, the intake gas is taken from the ambient atmosphere. In another embodiment, some or all of the intake gas is produced by RAs, such as those illustrated in the bank or set of RAs 900 (1-M).

d. Chemical Reactants for Engines

RAs as disclosed herein can produce the chemical reactants required for the chemical reactions needed to produce energy. The preceding Figures have illustrated arrangements of RAs to provide fuel, and other (optional) arrangements of RAs to provide oxidants. In more detail, one or more RAs can produce a supply of oxidizing agent to react with the fuel. This oxidizing agent is typically oxygen in most embodiments, although it could be other chemical or substance that will react appropriately with the fuel and satisfies an implementation's constraints. Oxidizing agents can include, for example, but without limitation; oxygen; or a halogen molecule such as chlorine (Cl₂), fluorine (F₂), and/or bromine (Br₂). In some embodiments, especially for those in which fluids (preferably gases) are easier to manage, hydrogen peroxide can be used as an oxidant. In some embodiments, the oxidizing agent can be produced, collected and managed by a system more or less similar to that assembling the fuel, but generally separated therefrom in order to prevent premature reaction between fuel and oxidizing agent until the fuel and oxidizing agent are combined in the reaction/combustion chamber. The oxidizing agent can be injected into a combustion chamber through a valve, port, injector, nozzle, turbocharger, or other means. In some implementations, a set or bank of RAs can produce oxidizing agent, which is used to combust a fuel provided conventionally such as from a storage tank or other process or source.

In many situations, such as when the engine operates in the earth's atmosphere where oxygen, the classic oxidizing agent, is freely and sufficiently abundant, there may be no need for the engine system to produce its own oxidizing agent. The ability of an engine system to produce its own oxidizing agent may be useful or important, however, in engine implementations designed to operate where oxygen is scarce, unavailable or impure (e.g., mixed with nitrogen or other gases). Engine systems that produce their own oxidizing agent can also rely in part on oxidizing agents sourced by other means, e.g., storage tanks or the like.

e. Control Systems for Engines

Engine systems embodying the principles of the invention can incorporate control systems to sense, monitor, regulate, and control various aspects of the implementation. The embodiments of engine systems depicted in FIGS. 11-14 illustrate certain features of these control systems, some of which have been described in connection with FIG. 10. As shown in FIGS. 11-14, a computer processor 100 can act as an electronic controller to integrate other aspects of the control system, and it is connected as needed to various components to receive sensor input signals, send control signals and the like. Computer processor 100 can be operatively coupled to a non-transitory storage device that stores executable instructions. The computer processor 100 can include a CPU(s) and/or a GPU(s) that reads instructions from a storage device and executes the instructions to perform functions and operations the instructions specify. In some embodiments, the computer processor 100 can comprise or consist of hardware such as a programmable or non-programmable gate array, an ASIC or any other suitable implementation comprising hardware and/or software. In some embodiments the computer processor 100 can be implemented as multiple processors not necessarily mutually connected or communicating. Computer processor 100 receives operating power 120 from the battery 200, from which it can also receive sensory signals 140 and to which it can send control signals. Embodiments of engine systems can have connections beyond those specifically illustrated here, from computer processor 100 to other components. For example, computer processor 100 can be operatively coupled to numerous input sensors; numerous output devices such as actuators, controls, regulators, displays and/or audio transducers; and a digital communication device such as a bus, a network, a wireless or wired data transceiver, etc., or other such equipment as may be deemed useful for operative coupling with the computer processor 100.

The processor 100, as well as the battery 200, can also be connected to the “start”/“ignition” switch (not shown) that activates the various components in response to a manual or automatically generated start event. In an embodiment, the “ignition”/“start” switch can activate the entire engine system including without limitation, all relevant components and sub-components, as appropriate.

In some embodiments, battery 200 provides ancillary power to various components in addition to powering the processor 100. Battery 200 is shown external to the engine, although in embodiments it can be internal to the engine. It can be connected to the engine's alternator/generator or other power generation 760, if present, to receive and maintain charge. In some implementations, battery 200 can be supplemented or replaced by other power sources such as solar panels, fuel cells, generators, alternators, or any external power sources, etc. Certain embodiments can have connections beyond those specifically illustrated here, from battery 200 to other components. Certain embodiments can include a battery 200 as an initial power source. In remote locations, in situations where battery acquisition, maintenance, or replacement may be difficult, or in emergency and special situations, motor units can be included that can be jump-started, manually operated, or be powered by alternate kinetic sources of current, or by solar panels.

Sensory and control connections 300/300′ are provided from computer 100 to the bank or set of RA(s) 500/900. Power lines 400 are provided from the battery 200 to the bank or set of RA(s) 500. Although nominally illustrated by abstract lines 300 and 300′ in the various Figures herein, the communication of signals and data between and among the various components of the invention should be understood to broadly encompass any means, including without limitation: electric, electronic, magnetic, electromagnetic, radio, wireless, optical, mechanical, hydraulic, thermal, sonic, physical, or quantum.

In FIGS. 11-14, “n” RA(s) 500 can be configured to assemble hydrogen or other fuel substance (where n is any integer greater than 0) and deliver such hydrogen or other fuel substance to the engine 700 as fuel. These “n” RA(s) 500/900 receive electrical power as needed, from battery 200 through 400. Similarly, in FIGS. 11-14, “m” RA(s) 900 can be configured to assemble oxygen or other oxidant (where m is any integer) and deliver this oxidant to the engine 700 as a reactant. These “m” RA(s) 900 receive power, as needed, from battery 200 through 400′. For illustrative simplicity, while all “power” connections to or from battery 200 are shown as a single line, they are intended to reflect a pair of conductors through which current flows. Aspects of the RA(s)500/900 are monitored and regulated by processor 100 through 300, which can comprise a data bus in one embodiment. The various monitored aspects can include, without limitation, power, temperature, humidity, configuration, pressure, flow, concentration, and any other relevant state; together with the operation of fans, pumps, valves, reservoirs, accumulators, pressurizers, compressors. The processor 100 can also control aspects of the state and operation of each RA 500/900 such as flow control, output rate, and any other relevant state or operation.

A fuel intake manifold in the form of conduit(s) 600 in the example shown is provided through which the fuel (hydrogen or otherwise, all encompassed by the term “fuel”) produced by RA(s) 500 is conducted to various cylinders/combustion chambers of the engine 700. The conduit(s) 600 can also convey hydrogen supplied by other fuel source(s), for example, a storage tank or other production process such as e.g., electrolysis for producing hydrogen. Such additional source(s) could be used in some embodiments and/or under some engine operating conditions in addition to RA(s) 500 to provide sufficient fuel/oxidant quantities and/or flow rates to meet demands of engine core 700. Item 670/670′ represents various aspects of conduits 600/600′ that can exist and be attached to processor 100 and battery 200.

f. Exemplary Operation of Engine System

In embodiments, engine systems incorporating the principles of the invention entail certain operational features pertaining to the production of power by the engine system, the use of the power to produce work, and the use of ancillary power or other complementary systems. In more detail, successful operation of an engine using one or more RSs may include carrying out the following steps:
1. creating the conditions necessary to support the instantiation of fuel materials using one or more RAs as described herein;
2. activating the one or more RAs once the prerequisite conditions are established;
3. sustaining, to the extent necessary, the activity of the one or more RAs once activated;
4. providing an oxidizing agent for use with the instantiated fuel to accomplish a chemical reaction, wherein the oxidizing agent is produced through its own bank or set of RAs or is provided from an external source
5. circulating and pumping the instantiated fuel and/or oxidizing agent as necessary;
6. pressurizing or compressing the fuel and/or oxidizing agent as necessary;
7. liquefying, gasifying, or otherwise changing the state of the fuel and/or oxidizing agent as necessary;
8. delivering the fuel and oxidizing agent to the combustion chamber on a schedule suitable for the specific engine category: for example, reciprocating piston engines can require delivery into a series of combustion chambers on a schedule that permits the combustion in each chamber to act upon the crankshaft in a timed manner;
9. activating the fuel-oxidizing agent reaction (combustion) as necessary; for example, some fuel and engine designs can require a spark for each cycle—much like traditional gasoline engines; others, such as diesel-style piston engines, turbines, and the like, may require only a single initiating event;
10. managing the exhaust as needed; and
11. handling cooling and radiator issues as required.

Generation and/or delivery of the fuel can involve various additional steps and/or structures, including for example and without limitation, those of being: pumped, collected, combined, e.g., combined with the output of other conduits or sources, pressurized, compressed, liquefied, solidified, stored, packaged, transported, hauled, unpackaged, repackaged, gasified, uncompressed, depressurized, filtered, mixed, agitated, centrifuged, shaken, oscillated, stirred, vibrated, gated, shunted, injected, diverted, merged, blown, aerated, propelled, spun, blended, dissolved, extracted, sensed, tested, humidified, dehumidified, monitored, measured, regulated, accumulated, cooled, heated, or otherwise processed. Such operations may involve the use of components including for example and without limitation: pumps, sensors, gates, shunts, injectors, valves, baffles, pipes, splitters, plumbing, relays, filters, controls, accumulators, tanks, containers, reservoirs, fans, blowers, propellers, impellors, aerators, agitators, oscillators, vibrators, shakers, stirrers, centrifuges, pressurizers, humidifiers, dehumidifiers, compressors, refrigerators, blenders, mixers, vats, dissolvers, extractors, coolers, heaters, gasifiers, liquefiers, and sensors and controls for flow, humidity, concentration, density, purity, particle size, particle diameter, particle surface area, particle weight, viscosity, temperature, volume, and pressure, as well as other sensors and controls and processing equipment. Each operation may be performed zero or more times, sometimes simultaneously, and the order in which they are performed (and whether they are appropriate or necessary) depends on a particular implementation's design, tradeoffs, and constraints.

Aside from those operational features that relate specifically to the production of fuel materials and/or oxidizing agents by RAs, the other steps in engine operation are familiar to skilled artisans. Conventional solutions to operational problems can be readily incorporated. For example, line current, batteries, or outside sources can be employed to start or to operate the system; once started, operation of the engine itself can also be employed to provide, as needed, ongoing mechanical energy to run a generator or to directly drive functions such as pumps, compressors, fans, turbines, turbochargers, etc. As another example, most types of engines mentioned (e.g., internal and external combustion engines generally, reciprocating piston engines, gas turbines, and the like) transmit mechanical energy through a central rotating shaft (e.g., a crankshaft in common internal combustion engine designs) from which ancillary power can be extracted. Ancillary power can also be provided by adding a second engine system operating conventionally or embodying the principles of the invention, wherein the second engine can act to assist the main engine.

While the power required to start a RA seems modest in many implementations, its correlation with an engine's performance has not been clearly determined. Furthermore, the fuel is likely to require at least an initial spark to incite combustion, and in some embodiments an additional spark(s) is needed for every engine cycle. Therefore, present understanding suggests that implementations advantageously provide an electrical source at least to start the engine's RA(s), activate the processor, provide ignition, and which can also be required to sustain the proper operating environment. In embodiments, RA chain reactions, once started, can continue instantiating material for use by an engine system with little or no additional ongoing power requirement as long as the proper operating environment is maintained.

In manufacturing an engine system that embodies the principles of the invention, an engine designer should further consider the material from which the engine is constructed and the lubrication issues. As an example, in certain cases hydrogen gas will be the chosen fuel, burned with either atmospheric oxygen, or with oxygen assembled onboard with RAs. The water resulting from this combustion reaction is not toxic and provides some degree of lubrication. However, in this case, materials used in engine design should be chosen to resist oxidation and rust, since both hot water vapor (steam) and incompletely burned oxygen will be present during combustion and in the exhaust. Designs should consider using strong, heat resistant, non-reactive materials for relevant parts of the engine, especially for surfaces. stainless steel, chromium, titanium, or even other low-reactive or non-reactive metals such as iridium, osmium, palladium, platinum, or gold, should be considered, as well as glass and various ceramics

### EXAMPLES

### Example 1: Energy/Light Combed Activation (E/LC)

One hundred milligrams (100 mg) of powdered carbon was placed in a GG-EL graphite tubular reactor (15.875 mm) OD, with ID machined to ˜9 mm). This reactor was inserted into a reactor assembly FIG. 2A and then placed into a high vacuum oven for degassing according to the Degassing Procedure (See Profile 1 or Profile 2). After degassing, the reactor assembly is transferred to a test cell for processing. Research-grade Nitrogen (N₂) was delivered at 2 SLPM to purge the system for a minimum of 25 seconds or more. The gases were fed through the E/MEE in a horizontal and level gas line, as described above. During purging, gas sampling lines are also purged. TEDLAR® sealed bags, when used, are connected to the sampling lines during the purge cycle.

Referring to FIG. 1, the argon “KC” light 108 located in position 0 (vertical lamp orientation; 7.62 cm from inlet or entrance flange; at 180°; bulb tip pointing up 2.54 cm from the outer diameter of the gas line) was turned on at the onset while simultaneously energizing the power supply to 5 amps. This light was kept on for a minimum hold time of 9 sec. Next light 109 in position 1 (109; horizontal lamp orientation; 7.62 cm from inlet or entrance flange; at 180°; bulb tip facing exit plate; bulb glass base at the optical entrance; 5.08 cm, from the outer diameter of the gas line), a krypton light, was turned on and the power is increased to 10 amps on the power supply. This was held for 3 seconds, light 107, in position 1 (107; horizontal lamp orientation; at 0°; bulb tip at the optical exit facing the exit plate; 5.04 cm from the outer diameter of the gas line), a xenon light was turned on and held for 9 seconds and the power was increased to 15 amps. After these 3 lights have been sequentially turned on, the sealed TEDLAR® bags are opened for gas collection, and the amperage delivered to reactor was adjusted to 100 amps and held for a minimum of 30 seconds. Immediately after the power was increased light 103 in position 1 (103; vertical lamp orientation; 7.62 cm from inlet or entrance flange; at 0°; bulb tip pointing down 2.54 cm from the outer diameter of the gas line), a neon light, was turned on.

Amperage harmonic patterning was then initiated on the reactor. With each amperage pattern (oscillation), the gases fed to the reactor can treated by the same or different light sequence. In one embodiment of the experimental protocol, the amperage of the reactor was increased to 78.5 amps over 1 second, the high-end harmonic pattern point. The amperage of the reactor was then decreased to 38.5 amps over 9 seconds and held at 38.5 amps for 3 seconds. Immediately at the start of the 3 second hold, an argon light 122 in position 1 (122; horizontal lamp orientation; at 180°; bulb tip pointing towards entrance plate at the optical entrance; 5.04 cm from the outer diameter of the gas line) was turned on. After the 3 second hold, amperage to the reactor was then ramped up to 78.5 amps over 9 seconds with a 3 second hold upon reaching 78.5 amps before a downward ramp was initiated. The reactor amperage was decreased to 38.5 amps, over 9 seconds and then held for 3 seconds. Immediately at the start of the 3 second hold, light 103 (103), a neon light in position 1, was turned on. The reactor amperage was again ramped up to 78.5 amps over 9 seconds, held there for 3 seconds, and then again ramped down to 38.5 amps over 9 seconds. A long-wave ultraviolet lamp (104; horizontal lamp orientation; at 90°; bulb tip facing entrance plate at the optical entrance; 5.04 cm from the outer diameter of the gas line) in position 1 was turned on.

The reactor was again ramped up to 78.5 amps over 9 seconds, held for 3 seconds, then decreased to 38.5 amps over another 9 seconds. Next a short-wave ultraviolet lamp (105 horizontal lamp orientation; 7.62 cm from inlet or entrance flange; at 270°; bulb tip at the optical entrance and facing the entrance plate; 5.04 cm from the outer diameter of the gas line) in the E/MEE (position 1) E/MEE section light was turned on and held for 3 seconds. The reactor was again ramped up to 78.5 amps over 9 seconds and held for 3 seconds. After the 3 second hold, the reactor amperage was decreased to 38.5 amps over another 9 seconds. The reactor was then held at 38.5 amps for 3 seconds, before another ramp up to 78.5 amps over 9 seconds was initiated. At 3 seconds into this ramp, lamp 107, in position 1 (107) was turned on and held there for the remaining 6 seconds of the 9 second total ramp. The reactor was held for 3 seconds in this condition.

The lights were turned off simultaneously in the E/MEE section as follows: (103), (108), (106), (105) and (104) and the reactor was deenergized. The reactor was held at this state, with continuous gas flow for 27 seconds during which the TEDLAR® bags are closed and removed. All remaining lights were turned off and gas flow continues for 240 seconds.

### Example 2: Degassing Profile 1

One hundred milligrams (100 mg) of powdered carbon was placed in a graphite tubular reactor (15.875 mm) OD, with ID machined to ˜9 mm), as described above and loaded into a closed end system. After ten closed end set-ups have been completed, each individual unit was loaded into the degassing oven openings and all incoming and outgoing lines were connected to the closed end systems. Isolated each incoming line to each reactor while maintaining the outgoing lines in an open position. Started the vacuum system until the vacuum gauge reads at least 750 mmHg. Upon reaching 750 MmHg, closed all outgoing line valves from the closed end systems and secured the vacuum pump. Performed a 30-minute leak test of the system. After successfully passing the leak check, opened each incoming line to the closed end system one at a time at 0.4 slpm N₂. Once all incoming lines were open and the vacuum gauge reached a slight positive pressure, opened the outgoing gas line on the degassing oven. Started the degassing oven profile ramping from T_{amb} to 400° C. over 1 hour while maintaining N₂ flow. After the 1-hour ramp, maintained flow for an additional hour for temperature stabilization while maintaining gas flow. After the temperature stabilization was complete, secured all incoming gas flows and isolated the degassing oven vent line. Immediately started the vacuum pump and begin the degassing protocol. Maintained the temperature and vacuum for 12 hours. After the 12 hours, allowed the oven to cool prior to closed end unit removal.

### Example 3: Degassing Profile 2

One hundred milligrams (100 mg) of powdered carbon was placed in a graphite tubular reactor (15.875 mm) OD, with ID machined to ˜9 mm), as described above and loaded into a closed end system. After ten closed end set-ups have been completed, each individual unit was loaded into the degassing oven openings and connected all incoming and outgoing lines to the closed end systems. Isolated each incoming line to each reactor while maintaining the outgoing lines in an open position. Started the vacuum system until the vacuum gauge reads at least 750 mmHg. Upon reaching 750 MmHg, closed all outgoing line valves from the closed end systems and secured the vacuum pump. Performed a 30-minute leak test of the system. After successfully passing the leak check, opened each incoming line to the closed end system one at a time at 0.4 SLPM N₂. Once all incoming lines were open and the vacuum gauge reached a slight positive pressure, opened the gas outgoing gas line on the degassing oven. Started the degassing oven profile ramping from 200° C.±50° C. to 400° C. over 1 hour while maintaining N₂ flow. After the 1-hour ramp, maintained flow for an additional hour for temperature stabilization while maintaining gas flow. After the temperature stabilization was complete, secured all incoming gas flows and isolated the degassing oven vent line. Immediately started the vacuum pump and began the degassing protocol. Maintained the temperature and vacuum for 12 hours. After the 12 hours, allowed the oven to cool prior to closed end unit removal.

### Example 4: Gas Analysis

For the chemical analysis of gas samples in TEDLAR® bags, a test protocol was developed based on the standard test method established for internal gas analysis of hermetically sealed devices. Prior to sample measurement, system background was determined by following exact measurement protocol that is used for sample gas. For system background and sample, a fixed volume of gas was introduced to the Pfeiffer QMA 200M quadrupole mass spectrometer (QMS) system through a capillary. Through a capillary, a fixed volume of gas was introduced to the Pfeiffer QMA 200M quadrupole mass spectrometer (QMS) system. After sample gas introduction, the ion current for specific masses (same as masses analyzed for system background) were measured. During background and sample gas analyses total pressure of the QMS system was also recorded, allowing for correction of the measured ion current.

TABLE 2
Gases analyzed for the test method and
measured masses used in deconvolution.

| Gas | Masses used for deconvolution |
|---|---|
| 1. Hydrogen | 2, 18, 55, 57 |
| 2. Helium (3) | 2, 4 |
| 3. Helium (4) | 4 |
| 4. Methane | 14, 15 |
| 5. Water | 18, 32, 40 |
| 6. Neon (20) | 18, 20, 40 |
| 7. Neon (22) | 20 |
| 8. Nitrogen | 14 |
| 9. Carbon Monoxide | 14, 28 |
| 10. Oxygen | 32 |
| 11. Argon | 40, 41, 43 |
| 12. Carbon Dioxide | 44 |
| 13. Tot. HC and Org. | 55, 57 |
| 14. Fluorocarbons | 69 |
| 15. Ammonia | 17, 18 |
| 16. Krypton | 84 |
| 17. Xenon | 132 |

### Data Analysis:

Measurements of the ion current for each mass were corrected to the average of measured background contributions corrected for pressure difference. Subsequent to the background correction, individual corrected mass signals were averaged and corrected to a known gas standard to determine the percent volume of 17 gas species. All corrections were determined using nitrogen and nitrogen-hydrogen mixture reference gases analyzed to match selected process gas for test samples using the developed protocol based on the standard test method, in accordance with Military Standard (MIL-STD-883) Test Method 1018, Microcircuits, Revision L, FSC/Area: 5962 (DLA, 16 Sep. 2019). Results below: 1%=10,000 ppm, Volume values for gas blanks and samples were produced using the developed gas analysis test method and validated using a gas mixture standard of 99.98% nitrogen and 0.02% hydrogen. All analytical performed by EAG Laboratories, Liverpool, NY using standard TEDLAR® bag gas sampling protocols and specified mass spectrometry methods.
Mass Analyzer: Quadrupole mass spectrometer (Pfeiffer QMA 200M)
Measurement mode: Analog scan for selected masses
No. of channels used: 64
Mass resolution: Unit resolution
Maximum detectable concentration: 100%
Minimum detectable concentration: 1 ppb
Background vacuum: <2×10⁻⁶ Torr

### Results:

### Protocol 1:

| Gases Analyzed (Vol %) | Ill. 1 | Ill. 2 | Ill. 3 | Ill. 4 | Ill. 5 |
|---|---|---|---|---|---|
| Hydrogen | 0.7678 | 0.2405 | 0 | 0 | 0.0162 |
| Helium (4) | 0.1923 | 0.2963 | 0.1928 | 0.5476 | 0.1254 |
| Methane (CH₄) | 0 | 0 | 0 | 0 | 0 |
| Water (H₂O) | 0.4054 | 1.0773 | 0 | 0 | 0 |
| Neon (20) | 0.036 | 0.03 | 0.0417 | 0.1789 | 0.0345 |
| Neon (22) | 0.0036 | 0.003 | 0.0042 | 0.0179 | 0.0035 |
| Nitrogen | 95.276 | 89.3705 | 99.347 | 88.2306 | 99.6251 |
| Carbon Monoxide (CO) | 0 | 0 | 0 | 0 | 0 |
| Oxygen | 3.1604 | 8.5606 | 0.3796 | 10.945 | 0.1826 |
| Argon | 0.0676 | 0.349 | 0.0003 | 0.08 | 0 |
| Carbon Dioxide (CO₂) | 0.0138 | 0 | 0 | 0 | 0 |
| Total Hydrocarbons and | 0.0269 | 0 | 0.0175 | 0 | 0 |
| Organics | | | | | |
| Fluorocarbons | 0.0261 | 0.0417 | 0.0162 | 0 | 0.0127 |
| Ammonia (NH₃) | 0 | 0.031 | 0 | 0 | 0 |
| Krypton | 0.0242 | 0 | 0 | 0 | 0 |
| Xenon | 0 | 0 | 0 | 0 | 0 |

| Gases Analyzed (Vol %) | Ill. 6 | Ill 7. | Ill. 8 | Ill. 9 |
|---|---|---|---|---|
| Hydrogen | 1.027 | 0 | 0 | 4.0494 |
| Helium (4) | 0.364 | 2.6033 | 0.2145 | 25.118 |
| Methane (CH₄) | 0 | 0 | 0 | 0 |
| Water (H₂O) | 0 | 0 | 0 | 0 |
| Neon (20) | 0.1093 | 0.4736 | 0.0308 | 5.6369 |
| Neon (22) | 0.0109 | 0.0474 | 0.0031 | 0.5637 |
| Nitrogen | 97.1911 | 94.6204 | 95.9834 | 56.538 |
| Carbon Monoxide (CO) | 0 | 0 | 0 | 0 |
| Oxygen | 1.2975 | 2.2553 | 3.7604 | 4.1726 |
| Argon | 0 | 0 | 0.0078 | 0 |
| Carbon Dioxide (CO₂) | 0 | 0 | 0 | 0 |
| Total Hydrocarbons and | 0 | 0 | 0 | 1.0654 |
| Organics | | | | |
| Fluorocarbons | 0 | 0 | 0 | 1.9565 |
| Ammonia (NH₃) | 0 | 0 | 0 | 0 |
| Krypton | 0 | 0 | 0 | 0.8997 |
| Xenon | 0 | 0 | 0 | 0 |

| Gases Analyzed (Vol. %) | Ill. 10 | Ill. 11 | Ill. 12 | Ill. 13 | Ill. 14 | Ill. 15 |
|---|---|---|---|---|---|---|
| Hydrogen | 0 | 1.0428 | 1.3437 | 0 | 1.6249 | 1.7941 |
| Helium (4) | 0.4679 | 0.3492 | 0.4409 | 0.8074 | 0.4888 | 0.6406 |
| Methane (CH₄) | 0 | 0 | 0 | 0 | 0 | 0 |
| Water (H₂O) | 0 | 2.3924 | 3.1436 | 0 | 4.4032 | 2.4182 |
| Neon (20) | 0.1598 | 0 | 0 | 0 | 0 | 0 |
| Neon (22) | 0.016 | 0 | 0 | 0 | 0 | 0 |
| Nitrogen | 76.7986 | 79.9798 | 94.2126 | 51.1046 | 92.2167 | 75.6209 |
| Carbon Monoxide | 0 | 0 | 0 | 0 | 0 | 0 |
| (CO) | | | | | | |
| Oxygen | 22.079 | 15.565 | 0.8348 | 48.088 | 1.239 | 18.7733 |
| Argon | 0.4639 | 0.5717 | 0 | 0 | 0 | 0.721 |
| Carbon Dioxide | 0 | 0.0991 | 0.0244 | 0 | 0.0274 | 0.0319 |
| (CO₂) | | | | | | |
| Total Hydrocarbons | 0 | 0 | 0 | 0 | 0 | 0 |
| and Organics | | | | | | |
| Fluorocarbons | 0.0147 | 0 | 0 | 0 | 0 | 0 |
| Ammonia (NH₃) | 0 | 0 | 0 | 0 | 0 | 0 |
| Krypton | 0 | 0 | 0 | 0 | 0 | 0 |
| Xenon | 0 | 0 | 0 | 0 | 0 | 0 |

| | Vol % |
|---|---|
| | Standard |
| | 99.98 vol % N₂/ |
| Gases Analyzed | 200 ppm H₂ |
| Hydrogen | 0.0223 |
| Helium (3) | 0.0000 |
| Helium (4) | 0.0000 |
| Methane (CH₄) | 0.0000 |
| Water (H₂O) | 0.0000 |
| Neon (20) | 0.0000 |
| Neon (22) | 0.0000 |
| Nitrogen | 99.9777 |
| Carbon Monoxide | 0.0000 |
| (CO) | |
| Oxygen | 0.0000 |
| Argon | 0.0000 |
| Carbon Dioxide (CO₂) | 0.0000 |
| Total Hydrocarbons | 0.0000 |
| and Organics | |
| Fluorocarbons | 0.0000 |
| Ammonia (NH₃) | 0.0000 |
| Krypton | 0.0000 |
| Xenon | 0.0000 |

The patent and scientific literature referred to herein establishes the knowledge that is available to those with skill in the art. All United States patents and published or unpublished United States patent applications cited herein are incorporated by reference. All published foreign patents and patent applications cited herein are hereby incorporated by reference. All other published references, documents, manuscripts and scientific literature cited herein are hereby incorporated by reference.

While this invention has been particularly shown and described with references to preferred embodiments thereof, it will be understood by those skilled in the art that various changes in form and details may be made therein without departing from the scope of the invention encompassed by the appended claims. Additionally, while the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims. Numerical values where presented in the specification and claims are understood to be approximate values (e.g., approximately or about) as would be determined by the person of ordinary skill in the art in the context of the value. For example, a stated value can be understood to mean within 10% of the stated value, unless the person of ordinary skill in the art would understand otherwise, such as a value that must be an integer.

1. An internal combustion engine comprising:
a first set of one or more reactor assemblies to instantiate a fuel for the engine;
a fuel delivery system in fluid communication with the one or more reactor assemblies and further in fluid communication with a combustion chamber, wherein the fuel delivery system delivers the fuel produced by the one or more reactor assemblies into the combustion chamber;
an oxidant delivery system in fluid communication with the combustion chamber, wherein the oxidant delivery system delivers an oxidizing agent into the combustion chamber to mix with the fuel therein to create a fuel mixture;
an ignition system operatively coupled to the combustion chamber, wherein the ignition system ignites the fuel mixture within the combustion chamber to produce a combustion, and wherein the combustion produces a gaseous combustion product that imparts a force to an engine component to produce work; and
an outlet conduit in fluid communication with the combustion chamber for removal of the gaseous combustion product from the combustion chamber following combustion.

2. The internal combustion engine of claim 1, wherein the internal combustion engine is configured as a continuous combustion engine or as an intermittent combustion engine.

3. (canceled)

4. The internal combustion engine of claim 2, wherein the intermittent combustion engine is a reciprocating engine or a rotary engine.

5. (canceled)

6. The internal combustion engine of claim 1, wherein the fuel comprises hydrogen.

7. (canceled)

8. The internal combustion engine of claim 1, wherein the oxidant delivery system is in fluid communication with a second set of one or more reactor assemblies, and wherein the second set of one or more reactor assemblies instantiates the oxidizing agent.

9. The internal combustion engine of claim 1, wherein the oxidizing agent comprises oxygen.

10. (canceled)

11. The internal combustion engine of claim 1, wherein the engine component is an internal engine component.

12. (canceled)

13. (canceled)

14. (canceled)

15. The internal combustion engine of claim 1, wherein the gaseous combustion product comprises a rapidly expanding gas, wherein the engine component is an external engine component, and wherein the outlet conduit directs the rapidly expanding gas to impart a force to the external engine component to produce the work.

16. (canceled)

17. (canceled)

18. An external combustion engine comprising:
a first set of one or more reactor assemblies to instantiate a fuel for the engine;
a fuel delivery system in fluid communication with the one or more reactor assemblies and further in fluid communication with a combustion chamber, wherein the fuel delivery system delivers the fuel produced by the one or more reactor assemblies into the combustion chamber;
an oxidant delivery system in fluid communication with the combustion chamber, wherein the oxidant delivery system delivers an oxidizing agent into the combustion chamber to mix with the fuel therein to create a fuel mixture;
an ignition system operatively coupled to the combustion chamber, wherein the ignition system ignites the fuel mixture within the combustion chamber to produce a combustion, and wherein the combustion forms gaseous combustion products and produces energy that is transferred to a working fluid in a separate compartment to produce work; and
an outlet conduit in fluid communication with the combustion chamber for removal of the gaseous combustion products from the combustion chamber following combustion.

19. The external combustion engine of claim 18, wherein the fuel comprises hydrogen.

20. (canceled)

21. The external combustion engine of claim 18, wherein the oxidant delivery system is in fluid communication with a second set of one or more reactor assemblies, and wherein the second set of one or more reactor assemblies instantiates the oxidizing agent.

22. (canceled)

23. The external combustion engine of claim 18, wherein the oxidizing agent comprises oxygen.

24. (canceled)

25. (canceled)

26. (canceled)

27. An engine energized by combustion of a fuel, comprising:
a set of one or more reactor assemblies that produces the fuel;
a fuel intake system in fluid communication with the set of one or more reactor assemblies and further in fluid communication with a combustion chamber, wherein the fuel intake delivers the fuel into the combustion chamber;
an oxidant delivery system in fluid communication with the combustion chamber, wherein the oxidant delivery system delivers an oxidizing agent into the combustion chamber;
a control system operatively coupled to the fuel intake system and the oxidant delivery system, wherein the control system regulates delivery of a preselected fuel amount and a preselected oxidizing agent amount into the combustion chamber, and wherein the control system triggers an ignition of the fuel and the oxidizing agent when the preselected fuel amount and the preselected oxidizing agent amount are present in the combustion chamber; and
an ignition system operatively coupled to the combustion chamber and triggered by the control system, wherein the ignition system ignites the fuel and the oxidizing agent to produce combustion of the fuel, and wherein the combustion of the fuel produces energy that energizes the engine.

28. (canceled)

29. The engine of claim 27, wherein the fuel comprises hydrogen.

30. The engine of claim 27, wherein the set of one or more reactor assemblies comprises a plurality of reactor assemblies.

31. (canceled)

32. The engine of claim 27, wherein the oxidizing agent comprises oxygen.

33. The engine of claim 27, wherein the oxidizing agent comprises a halogen molecule.

34. The engine of claim 27, further comprising an auxiliary set of reactor assemblies that produces the oxidizing agent, wherein the auxiliary set of reactor assemblies is in fluid communication with the oxidant delivery system, and wherein the auxiliary set of reactor assemblies produces at least a portion of the preselected oxidizing agent amount in the combustion chamber used for combustion.

35. The engine of claim 27, further comprising an exhaust system, wherein the exhaust system expels byproducts of combustion from the combustion chamber.

36. A process for energizing an engine, comprising:
(a) producing a fuel for the engine, wherein the step of producing comprises the following steps:
(i) adding a feed gas to an electromagnetic embedding apparatus:
(ii) exposing the feed gas to at least one E/MEE light source;
(iii) directing the feed gas from step (ii) to a reactor assembly comprising:
a gas inlet and one or more gas outlets;
a reactor chamber containing a nanoporous carbon disposed within a cup and, optionally, covered with a cap;
a first porous frit defining a floor of the reactor chamber disposed within the cup,
a second porous frit defining the ceiling of the reactor chamber; wherein each porous frit has a porosity that is sufficient to allow a gas to permeate into the reactor chamber;
a reactor head space disposed above the reactor chamber;
at least one RA coil surrounding the reactor chamber and/or reactor head space operably connected to a power supply, wherein the computer processing unit is configured to control the power supply to the RA coil;
(iv) subjecting the nanoporous carbon powder to harmonic patterning to instantiate a product gas comprising the fuel; and
(v) collecting the product gas comprising the fuel;
(b) delivering the fuel into a combustion chamber of the engine;
(c) delivering an oxidant into the combustion chamber to mix with the fuel, thereby forming a combustible fuel mixture; and
(d) igniting the combustible fuel mixture, thereby creating energy to energize the engine.
